(19) United States
(12) Patent Application Publication
(10) Pub. No.: US 2025/0069400 A1
(43) Pub. Date: Feb. 27, 2025

(54) YARD VISION SYSTEM

(71) Applicant: Macondo Vision, Inc., Atlanta, GA (US)

(72) Inventors: Bryan McCormick Kelly, Alamo, CA (US); Debbie Fortnum, Charlotte, NC (US); Frank Layo, Atlanta, GA (US)

(73) Assignee: Macondo Vision, Inc., Atlanta, GA (US)

(21) Appl. No.: 18/452,596

(22) Filed: Aug. 21, 2023

(51) Int. Cl. G06V 20/52; G06T 7/246; G06T 7/73

(52) U.S. Cl. CPC G06V 20/52; G06T 7/246; G06T 7/73

(57) ABSTRACT

Disclosed is an area monitoring system including a camera module having configured to generate an output representative of a captured image and/or a video of an area including a object. The system includes a state machine including an inference engine configured to: identify and track an object; establish a state and/or a change in state of an object via machine vision inferencing; and generate an output representative of an object identification, an object state, and/or a change in an object's state. The state machine module includes a mapping engine configured to: process the camera module output to assign coordinates to an object contained in an image and/or a video based on a coordinate system of a computer vision map of an area; apply a timestamp in connection with assigning coordinates an object; and generate a coordinate timeseries log for plural coordinate-timestamp pairs.

### FIELD

Embodiments can relate to a monitoring and tracking system including cameras configured to passively capture activity in a truck/trailer yard that is fed into an associated artificial intelligence (AI) system. The system can monitor real-time location and status and can be used independently or to augment an existing Yard Management System (YMS) to improve accuracy and efficiency in a trailer yard.

### BACKGROUND INFORMATION

Yard Management Systems (YMS) are used to efficiently manage inventory and equipment in truck/trailer yards at manufacturing or distribution centers. Such systems typically involve tracking, organizing, and scheduling the movement of items and equipment within the yard, as well as monitoring their status and location. Trucks and trailers are often checked in at a gate by a guard and then directed to a parking stall or dock door at the building. This location is then entered into the YMS. However, truck drivers may park in the wrong location which leads to an error in the YMS. Later, when this trailer is needed, an employee will need to search the yard because it is not physically where the system shows it to be. This is an extremely time-consuming and labor-intensive process that slows down operations, creates delays in the supply chain, and can cost operators millions of dollars. Additionally, inventory and equipment may become lost as their location and status are now incorrect.

What is needed is a YMS augmented with real-time status and location tracking to eliminate lost equipment and wasted time to enable a more efficient and cost-effective supply chain. A Yard Vision System that could be used standalone or as a feed into an existing YMS that monitors yard operations and tracks actual movements and events in real-time is this solution.

### SUMMARY

An exemplary embodiment can relate to a marshalling area monitoring system. The marshalling area monitoring system can include a camera module having one or more cameras configured to generate an output representative of a captured image and/or a video of a marshalling area including one or more objects entering, within, and/or leaving a marshalling area. The marshalling area monitoring system can include a state machine module configured to receive the output from the camera module. The state machine module can include an inference engine configured to: identify and track an object; establish a state and/or a change in state of an object via machine vision inferencing; and generate an output representative of an object identification, an object state, and/or a change in an object's state. The state machine module can include a mapping engine configured to: process the camera module output to assign coordinates to an object contained in an image and/or a video based on a coordinate system of a computer vision map of a marshalling area; apply a timestamp in connection with assigning coordinates an object; and generate a coordinate timeseries log for plural coordinate-timestamp pairs.

An exemplary embodiment can relate to a yard management system. The yard management system can include an embodiment of a marshalling area monitoring system disclosed herein. The state machine module of the marshalling area monitoring system, using the coordinate timeseries log, can be configured to generate a time-in-marshalling area log for an object, the time-in-marshalling area log including one or more of: time and location of entrance into a marshalling area; time and location of object-in-stationary position; time and location of object-in-motion; and time and location of exit from a marshalling area. The yard management system can include a yard management system (YMS) module configured to transmit and/or receive data, via a bi-communication approach or protocol, to/from an asset management system (AMS).

### BRIEF DESCRIPTION OF THE DRAWINGS

Other features and advantages of the present disclosure will become more apparent upon reading the following detailed description in conjunction with the accompanying drawings, wherein like elements are designated by like numerals, and wherein:

FIG. 1 shows an exemplary system diagram for an embodiment of the marshalling area monitoring system;

FIG. 2 shows a top-down view of a distribution center and trailer yard with an exemplary AI cameras and systems to track the operations of the yard;

FIG. 3 shows an exemplary set up of a series of five overlapping cameras attached to the distribution center overlooking the trailer yard;

FIG. 4 shows a description of an exemplary implementation of how the neural network can be trained to track trucks and trailers in the yard;

FIG. 5 shows an exemplary set up of a series of cameras connected to an Edge AI Camera Server running NVIDIA DeepStream™ and custom neural networks used by an embodiment of the application;

FIG. 6 shows a description of an exemplary implementation of how optical character recognition (OCR) neural network can be trained/created for use to read the markings off the trailer as it enters the property;

FIG. 7 shows an exemplary implementation by which data is collected by the AI object detection from a gate camera;

FIG. 8 shows an exemplary web portal that shows all the trailers that enter the facility and the OCR that has been done on the backs of the trailers;

FIG. 9 shows an exemplary a web portal showing exemplary YMS (Yard Management System) data collected by human employees at the gate when a trailer enters the yard;

FIGS. 10-11 shows an exemplary camera overlap linkage map that can be used by the system to track trailers as they move from one camera to the next in the trailer yard;

FIG. 12 shows an exemplary camera linkage neural network creation process, wherein the outcome of this process can allow the tracking IDs from a trailer on one camera to be linked to the tracking ID on another adjacent overlapping camera;

FIG. 13 shows an exemplary set up in which two overlapping cameras track the same truck as it is seen by two different cameras;

FIG. 14 shows how camera specific tracking IDs can be linked together into a global tracking ID as the trailer does its journey throughout the trailer yard;

FIG. 15 shows a photo of how the individual parking stalls/positions can be automatically learned prior to deployment, wherein human labeled names can be given to the parking positions;

FIG. 16 shows an exemplary process of how, during live operations, the system can determine if a truck is parked at a specific position by using Intersection over Union (IOU) calculations;

FIG. 17 shows an exemplary web-based dashboard with trailers parked in various positions based upon what the Yard Vision System determined;

FIG. 18 shows an exemplary web-based dashboard showing the Trailer move history as determined by the Yard Vision System and the YMS;

FIG. 19 shows an exemplary linkage between a Yard Vision System (YVS) and a Warehouse Management System (WMS) to allow for notification and automatic updates of the YMS;

FIG. 20 shows an exemplary physical infrastructure of the Yard Vision System from the Edge (on-premises) to the Cloud; and

FIG. 21 shows exemplary Cloud based software modules that can be combined into a Yard Vision System.

### DETAILED DESCRIPTION

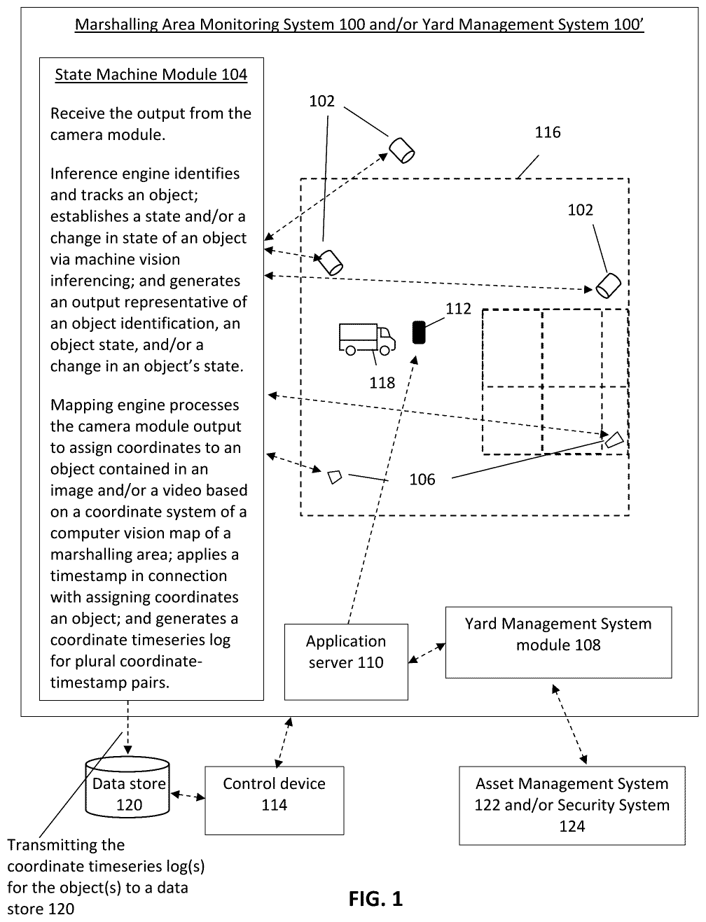

Referring to FIG. 1, embodiments can relate to a marshalling area monitoring system 100. While exemplary embodiments discuss and illustrate a marshalling area 116 as the area, it is understood that the area can be any area (e.g., parking lot, warehouse floor, etc.). A marshalling area can include a location in the vicinity of a reception terminal or pre-positioned equipment storage site where arriving unit personnel, equipment, materiel, and/or accompanying supplies can be reassembled, staged, maintenanced, inventoried, accounted for, etc.

Embodiments of the marshalling area monitoring system 100 can include one or more processors. Any of the components of the marshalling area monitoring system 100 (e.g., camera module 102, camera 200, state machine module 104, sensor module 106, yard management system module 108, application server 110, mobile electronic device 112, etc.) can include one or more processors. Any of the processors disclosed herein can be part of or in communication with a machine (e.g., a computer device, a logic device, a circuit, an operating module (hardware, software, and/or firmware), etc.). The processor can be hardware (e.g., processor, integrated circuit, central processing unit, microprocessor, core processor, computer device, etc.), firmware, software, etc. configured to perform operations by execution of instructions embodied in computer program code, algorithms, program logic, control, logic, data processing program logic, artificial intelligence programming, machine learning programming, artificial neural network programming, automated reasoning programming, etc. The processor can receive, process, and/or store data related to any aspect of the marshalling area monitoring system 100.

Any of the processors disclosed herein can be a scalable processor, a parallelizable processor, a multi-thread processing processor, etc. The processor can be a computer in which the processing power is selected as a function of anticipated network traffic (e.g., data flow). The processor can include any integrated circuit or other electronic device (or collection of devices) capable of performing an operation on at least one instruction, which can include a Reduced Instruction Set Core (RISC) processor, a Complex Instruction Set Computer (CISC) microprocessor, a Microcontroller Unit (MCU), a CISC-based Central Processing Unit (CPU), a Digital Signal Processor (DSP), a Graphics Processing Unit (GPU), a Field Programmable Gate Array (FPGA), etc. The hardware of such devices may be integrated onto a single substrate (e.g., silicon “die”), or distributed among two or more substrates. Various functional aspects of the processor may be implemented solely as software or firmware associated with the processor.

The processor can include one or more processing or operating modules. A processing or operating module can be a software or firmware operating module configured to implement any of the functions disclosed herein. The processing or operating module can be embodied as software and stored in memory, the memory being operatively associated with the processor. A processing module can be embodied as a web application, a desktop application, a console application, etc.

The processor can include or be associated with a computer or machine readable medium. The computer or machine readable medium can include memory. Any of the memory discussed herein can be computer readable memory configured to store data. The memory can include a volatile or non-volatile, transitory or non-transitory memory, and be embodied as an in-memory, an active memory, a cloud memory, etc. Examples of memory can include flash memory, Random Access Memory (RAM), Read Only Memory (ROM), Programmable Read only Memory (PROM), Erasable Programmable Read only Memory (EPROM), Electronically Erasable Programmable Read only Memory (EEPROM), FLASH-EPROM, Compact Disc (CD)-ROM, Digital Optical Disc DVD), optical storage, optical medium, a carrier wave, magnetic cassettes, magnetic tape, magnetic disk storage or other magnetic storage devices, or any other medium which can be used to store the desired information and which can accessed by the processor.

The memory can be a non-transitory computer-readable medium. The term “computer-readable medium” (or “machine-readable medium”) as used herein is an extensible term that refers to any medium or any memory, that participates in providing instructions to the processor for execution, or any mechanism for storing or transmitting information in a form readable by a machine (e.g., a computer). Such a medium may store computer-executable instructions to be executed by a processing element and/or control logic, and data which is manipulated by a processing element and/or control logic, and may take many forms, including but not limited to, non-volatile medium, volatile medium, transmission media, etc. The computer or machine readable medium can be configured to store one or more instructions thereon. The instructions can be in the form of algorithms, program logic, etc. that cause the processor to execute any of the functions disclosed herein.

Embodiments of the memory can include a processor module and other circuitry to allow for the transfer of data to and from the memory, which can include to and from other components of a communication system. This transfer can be via hardwire or wireless transmission. The communication system can include transceivers, which can be used in combination with switches, receivers, transmitters, routers, gateways, wave-guides, etc. to facilitate communications via a communication approach or protocol for controlled and coordinated signal transmission and processing to any other component or combination of components of the communication system. The transmission can be via a communication link. The communication link can be electronic-based, optical-based, opto-electronic-based, quantum-based, etc. Communications can be via Bluetooth, near field communications, cellular communications, telemetry communications, Internet communications, etc.

Transmission of data and signals can be via transmission media. Transmission media can include coaxial cables, copper wire, fiber optics, etc. Transmission media can also take the form of acoustic or light waves, such as those generated during radio-wave and infrared data communications, or other form of propagated signals (e.g., carrier waves, digital signals, etc.).

Any processor of the marshalling area monitoring system 100 or component of the marshalling area monitoring system 100 can be in communication with another processor of the marshalling area monitoring system 100, another processor of a component of the marshalling area monitoring system 100, and/or another other processor of another device (e.g., a computer device, a computer system, a laptop computer, a desktop computer, a server, etc.). Any of the processors can have transceivers or other communication devices/circuitry to facilitate transmission and reception of wireless signals. Any of the processors can include an Application Programming Interface (API) as a software intermediary that allows two or more applications to talk to each other.

As will be explained herein, embodiments of the marshalling area monitoring system 100 can have camera modules 102, cameras 200, state machine modules 104, etc. Embodiments can include one or more marshalling area monitoring systems 100, one or more marshalling area monitoring systems 100 in communication with another type of system (e.g., security system, asset management system, yard management system, supply chain management system, etc.), one or more sub-systems (these can be another marshalling area monitoring system 100 or a different type of system) within a marshalling area monitoring system 100, etc. Any of the systems 100 or components of the systems 100 can include a control device 114 (e.g., a computer device) configured to collect data, transmit command signals, coordinate activities, etc. of a system 100 or a component of a system 100. The control device 114 can be part of the system 100 or in communication with the system 100 via a communication interface. Any of the components can include servos or other equipment to allow it to be operated by the control device 114. The control device 114 can be operated by a human user, by programming logic, artificial intelligence, or a combination thereof. The control device 114 can be used to turn cameras 200 on/off, point cameras 200 in certain directions, dictate the type and degree of operation the state machine module 104 performs, determine optimal times for camera operation, determine optimal data processing techniques, etc. The control device 114 can also determine which component performs computational functions or data processing, can allocate computational functions or data processing amongst different components, can send data to components that are not part of the marshalling area monitoring system 100 but that are in communication with it for computational functions or data processing, etc.

Exemplary embodiments may describe a component (e.g., a camera module 102, a state machine module 104, etc.) as part of the marshalling area monitoring system 100, but it is understood that any of these components can be in communication with the marshalling area monitoring system 100 as opposed to being a part of the marshalling area monitoring system 100. In addition, exemplary embodiments may describe the marshalling area monitoring system 100 and its components as being on-site (e.g., within the marshalling area), but it is understood that any component can be off-site.

Exemplary embodiments may describe a marshalling area monitoring system 100 with separate and distinct components (e.g., a camera module 102, a state machine module 104, etc.), but it is understood that any of the components can be together as a single unit (e.g., a camera module 102 can include a state machine module 104). In addition, embodiments may describe a module (e.g., a state machine module 104) as having separate and distinct engines (e.g., an inference engine, a mapping engine, etc.), but it is understood that these can be in a single engine (e.g., an inferencing and mapping engine).

The marshalling area monitoring system 100 can include a camera module 102. There can be more than one camera module 102. Each camera module 102 can include one or more cameras 200. Each camera 200 can be configured to generate an image and/or video of an area of interest (e.g., a marshalling area, a sector of the marshalling area, etc.). The camera 200 can send the image and/or video to a processor of the camera module 102 to be processed. For instance, the camera module 102 can digitize the image and/or video, perform other signal processing (e.g., Gabor filtering, foveation, etc.) store it in memory of the camera module 102, etc. The camera 200 can be a stationary camera, a scanning camera, a motion detection camera, have infrared imaging capabilities, zoom capabilities, etc.

Any one or more of the camera modules 102 can generate an output representative of a captured image and/or a video of a marshalling area 116. For instance, a camera 200 that generates and image and/or video and stores it can be considered “captured”. The captured image and/or video can be processed by the processor and converted into an output (e.g., a digital or analog signal) that is representative of the captured image and/or video. The image and/or video can be of the marshalling area 116, a sector of the marshalling area 116, an object 118 of the marshalling area 116, an object 118 entering, within, and/or leaving a marshalling area 116, etc.

The marshalling area monitoring system 100 can include a state machine module 104 configured to receive the output from the camera module 102. There can be one or more state machine modules 104. The state machine module 104 can include programming (e.g., artificial intelligence) configured to analyze the output (which is a representation of a captured image and/or a video of the marshalling area 116, a sector of the marshalling area 116, and/or an object 118) and determine and/or predict a state for the marshalling area 116, a sector of the marshalling area 116, and/or an object 118. The state machine module 104 can establish a state and/or a change in state of an object 118 via machine vision inferencing. The state machine module 104 can then generate an output representative of an object 118 identification, an object 118 state, and/or a change in an object's 118 state. The state can be whether the object 118 is in a proper location, whether the object's 118 pattern of movement indicates a behavior that is appropriate, whether the object's 118 movement is safe or unsafe, etc. While other sensor data can be used, it is noted that this state determination and/or prediction can be based solely on the image and/or video output received when applied to predictive analytics, inferencing techniques, etc.

The state machine module 104 can include an inference engine configured to identify and track an object 118. For instance, the inference engine can be configured to identify and track an object 118 using on one or more of a convolution neural network technique (e.g., feature extraction object tracking), a transformer technique, etc. Once identified, the object 118 can be tagged so that when it appears again in another image/video, the state machine module 104 associates it with the already identified object 118. It is understood that the state machine module 104 can identify and track one or more objects 118 within the captured image and/or video.

The state machine module 104 can include a mapping engine configured to process the camera module 102 output to assign coordinates to an object 118 contained in an image and/or a video based on a coordinate system of a computer vision map of a marshalling area 116. For instance, the state machine module 104 can have priori images of the marshalling area 116 of when the marshalling area 116 had no object 118. A computer vision map of the marshalling area 116 can be generated, and a coordinate system superimposed thereon. Once an object 118 is detected, the mapping engine can assign coordinates to the object 118. The mapping engine can receive multiple images and/or video of the object 118 which may or may not be from the same camera 200—e.g., it can receive a time series of images/video of the object 118. The mapping engine can assign coordinates to the object 118 over a period of time. The mapping engine can apply a timestamp in connection with assigning coordinates an object 118 (e.g., via metadata). The mapping engine can generate a coordinate timeseries log for plural coordinate-timestamp pairs. The mapping engine can be configured to assign coordinates to an object 118 contained in an image and/or a video continuously, at predetermined times, when a change in movement or direction of an object is detected, when an object 118 is stationary for a predetermined time, etc.

The mapping engine functions can allow the marshalling area monitoring system 100 to monitor objects' 118 movement relative to a coordinate system of the marshalling area 116 and over time. As will be explained herein, an intended use of the marshalling area monitoring system 100 can be to identify and track delivery and carrier trucks in a trucking yard. A beneficial aspect of the marshalling area monitoring system 100 is to do this without having to force the truck drivers to park in designated spots—e.g., the truck driver can park where they feel is most practical or expedient. The marshalling area monitoring system 100, via this mapping engine function, can still track movement of the truck while allowing the truck driver to move about the truck yard freely. This mapping engine function also provides position, speed, trajectory, etc. information of the object 118 for the inference engine.

An object 118 can be one or more of a human, an animal, a vehicle, a tractor-trailer, a device, an item, an article of clothing, etc. It is contemplated for not only trucks to be identified and tracked, but also other objects 118, such as the truck driver, yard employees, other type of vehicles moving about in the yard, etc. The machine vision inferencing can use identification of a person wearing a certain type of vest or headgear to identify that person as an authorized employee, or use physical features to identify that person as Truck-driver A and associate that person with Truck A, or identify the person as an employee but that the employee is not wearing required personal protective equipment (PPE) such as gloves, ear plugs, a hardhat, etc., or identify a person as having contraband (e.g., a weapon), or identify the person as an unauthorized individual, or identify the vehicle as an unauthorized vehicle by identifying features or marks on the vehicle, etc. These identifications, along with the mapping engine functions discussed above, can assist the inference engine to determine and/or predict states for the marshalling area 116, sectors of the marshalling area 116, one or more objects 118, etc. Some objects 118 can be fixtures of the marshalling area 116 (e.g., guard rails, light posts, fences, etc.). The inference engine, via the machine vision inferencing, can identify that fixture object 118 by its physical shape and location, and if that fixture object 118 is damaged (e.g., has a different shape, has moved, etc.) the inference engine can determine that it had been damaged. The state machine module 104 can then generate a signal to indicate the same—e.g., the signal can be transmitted to the control device 114. The control device 114 can generate an audio and/or visual signal to alert administrators of the system 100.

The state machine module 104 can be configured to identify an object 118 by identifying one or more features that are unique to the object 118. Identifying one or more unique features of the object 118 can include identifying a text, a number, a shape, a color, etc. associated with an object 118. For instance, a textual and/or numerical mark on a vehicle (e.g., license number, DOT number, etc.) can be identified from the image/video via a text or number recognition technique (e.g., optical character recognition). This unique feature can be tagged and/or associated with the tag of the object 118.

As can be appreciated from the above, identifying an object 118 can include identifying a type of an object as a human, an animal, a vehicle, a tractor-trailer, a device, an item, an article of clothing, etc. Identifying an object 118 can include identifying a subtype of an object 118, including a class or category of a human (e.g., employee, not an employee, etc.), an animal (e.g., a bird, a deer, etc.), a vehicle (e.g., delivery truck, a visitor car, etc.), a device (e.g., a tool, a weapon, etc.), an item (e.g., a fixture, garbage, etc.), an article of clothing (e.g., a hat, earplugs, a vest, etc.), etc.

Identifying a state of an object 118 can include determining or predicting whether an object 118 is or will be authorized, unauthorized, admissible, not admissible, compliant, noncompliant, safe, in danger, etc. For instance, a person wearing a certain headgear can be identified as an employee (authorized) and in sector 1 (safe), but is moving toward sector 2 (a dangerous area) without any PPE, and thus is about to be noncompliant and in danger. As another example, the state machine module 104 can identify a trailer parked without its legs extended and identifies the truck driver decoupling the trailer from the truck and entering the truck. The state machine module, using machine vision inferencing, can predict that a possible dangerous situation is about to occur—the truck is about to pull away without the trailer's legs deployed in an extended state. Identifying a state of an object 118 can include determining or predicting whether an object is or will be in a proper location. For instance, the state machine module 104 can identify a certain type of delivery truck parking at a coordinate of the marshalling area 116 that is not practical or conducive for the type of delivery. Identifying a state of an object 118 can include determining or predicting whether an object's 118 behavior is or will be appropriate. For instance, the state machine module 104 can identify a person is hanging on the back of a trailer as the truck is moving, and therefore the behavior is inappropriate. Identifying a state of an object 118 can include determining or predicting whether an object's movement, speed, or trajectory is or will be acceptable. For instance, the state machine module 104 can determine or predict that a truck's speed is too fast, and is therefore unacceptable. Identifying a state of an object 118 can include determining or predicting whether an occurrence is creating or will create a state or a change in state. Identifying a state of an object 118 can include determining or predicting whether a state of an object indicates it is likely to collide with another object.

An example of detecting speed via machine vision inferencing, can be as follows. Calibration videos of trucks driving at known speeds in the yard below, at, and above a speed threshold that the management says is their speed limit for the yard (e.g., 20 mph) can be created. From the object detector and tracking software, the system 100 can map the truck driving at 20 mph across the cameras 200 by using the pixels per frame of movement and where on each camera 200 the truck is. It should be noted that there are more pixels per frame movement in the center of the screen verses on the outer sides of the screen due to lens warping and perspective view, and thus creating a calibration map for the speed limit can be beneficial in this regard. At runtime, the system 100 can easily determine if the driver exceed the 20 mph or x pixels/frame based upon where the driver is on that camera 200. In addition, or in the alternative, key coordinate points in the marshalling area 116 that are on computer vision map of a marshalling area 116 can be used as reference points to calculate the truck's speed and trajectory as it moves and coordinates are assigned to it. For instance, the state machine module 104 can associate one or more features (e.g., an object 118 that is a fixture of the marshalling area 116) that are unique to a marshalling area 116 to a coordinate of the computer vision map. This can be used as a key coordinate point.

With the exemplary embodiment of the area being a marshalling area 116, the marshalling area can include one or more of a parking lot, an airport tarmac, a harbor, a marina, a shipping yard, a trucking yard, a railroad yard, a motorpool, a staging area, a distribution center, warehouse, etc. A class of category of the human can include one or more of an employee, a contractor, an operator, a customer, a visitor, an authorized individual, an unauthorized individual, etc. A class or category of the animal can include one or more of a dangerous animal, a non-dangerous animal, etc. A class or category of the vehicle can include one or more of a personal vehicle, a commercial vehicle, a delivery vehicle, a construction vehicle, a water vessel, an aircraft, a drone, an autonomous robot, bicycle, a scooter, etc. A class or category of the device can include one or more of a computer, a camera, a surveillance apparatus, a tool, a piece of equipment, a weapon, contraband, etc. A class of category of the item can include one or more of a light post, a barrier, a curb, a fence, a dock, a doorway, an unidentified object, etc. A class or category of the article of clothing can include work attire, non-work attire, safety attire, PPE, etc.

It is contemplated for the inference engine to be configured to identify and track an occurrence that will cause or is likely to cause a change in a state. This can be a truck's speed and trajectory towards another truck, a person about to move a truck with an attached trailer and the trailer legs are deployed, a trailer sitting in the yard for an extended period of time without the contents of the trailer being removed (e.g., spoilage), etc. It is further contemplated for the inference engine to be configured to determine a change in the state of an object 118 based on plural states of an object 118 and one or more tracked behavior, movement, and/or occurrence for each state of plural states. For instance, an object can have one or more states and those states can be changing over time, leading to a plurality of states for the object 118. Other objects 118 can also have a plurality of states. These plurality of states of one or more objects 118 and the behavior(s), movement(s), and/or occurrences tracked by the state machine module 104 can provide a situational awareness for the object(s) 118 and the marshalling area 116. The state machine module 104 can use this to determine, update, and/or predict a state of any one or more object 118.

The inference engine can be configured to generate a trigger event signal based on a state of an object 118 and/or a change in a state of an object 118. This trigger event signal can be analyzed by the state machine module 104 to determine if a message should be transmitted indicating that action should be taken to address the state or change in state. This can be done by using logic rules pertaining to safety, operational efficiency, etc. For instance, if a trigger event causes the state machine module 104 to predict a change in state of an object 118 from a safe condition to an unsafe condition, then the state machine module 104 can generate an alert message or a command message to the control device 114 to cause it to generate an alert message.

As noted above, the state determination and/or prediction can be achieved by applying the camera module output(s) to predictive analytics, inferencing techniques, etc. The current state of the object 118 and/or other objects 118, plurality of states for the object 118 and/or other object 118, situational awareness of the marshalling area 116, etc. can be factored when doing this. A non-limiting example can be the state machine module 104 having a predictive model or having access to a predictive model that includes trained data sets on various objects 118 and states for those objects 118. The predictive model can use predictive analytics (e.g., multivariate regression, logistic regression, decision tree analysis, neural network analysis) to determine a best match between the current data and the trained data. The predictive model can include one or more of a forecast model, a classification model, an outliers model, a clustering model, a time series model, etc. A degree of match can be assessed by a confidence score or other numerical method.

It is contemplated for the camera module output to include an image and/or a video at a point of ingress and/or at a point of egress of a marshalling area 116. For instance, the camera module 102 can include a camera 200 configured to capture an image/video at the point of ingress and a camera 200 configured to capture an image/video at the point of egress. The points of ingress and egress may be at the same location or be close enough such that only one camera 200 is needed to capture both. With this set up, the marshalling area monitoring system 100 can identify and track objects 118 as soon as they enter the area 116, track them the entire time they are in the area 116, and track when they leave the area 116. It is further contemplated for at least one camera 200 of the camera module 102 to be configured to capture an image and/or a video of a marshalling area 116 that at least partially overlaps in geometric space with an image and/or a video captured by another camera 200 of the camera module 102. This can ensure that there is redundant coverage. This can also assist in tracking the object 118, as when the object 118 leaves the field of view of one camera 200 it is already in the field of view of another camera 200. Depending on the design criteria of the system 100, the system 100 may be set up such that there is at least one camera 200 having a field of view that overlaps with another camera's 200 field of view. This can be done for each camera 200 of the system 100.

With a point of ingress capture point, point of egress capture point, and overlapping camera 200 arrangement, the state machine module 104, using the coordinate timeseries log for the object 118, can be configured to generate a time-in-marshalling area log for an object 118. The time-in-marshalling area log can include: time and location of entrance into a marshalling area 116 (e.g., a time and location the object 118 entered into the area 116); time and location of object-in-stationary position (e.g., a time(s) and location(s) the object 118 was not in motion); time and location of object-in-motion (e.g., a time(s) and location(s) the object 118 was in motion); and/or time and location of exit from a marshalling area 116 (e.g., a time and location the object 118 exited from the area 116).

Any of the components of the system 100, or the system 100 itself, can transmit any of the data to a date store 120. For instance, the state machine module 104 can be configured to transmit the coordinate timeseries log to a data store 120. Any of the components of the system 100 can access the data store 120 to pull data therefrom, analyze it, process it, etc. and transmit it back to the data store 120. The data store 120 can be memory, a database, a computer device, a sever, a cloud server, etc. The data store 120 can be part of the marshalling area monitoring system 100 or part of a marshalling area management system that is separate from the marshalling area monitoring system 100. The marshalling area monitoring system 100 can be in communication with a marshalling area management system or be part of the marshalling area management system.

In some embodiments, the state machine module 104 can be configured to receive sensor data from one or more sensor modules 106. The sensor module 106 can be part of the system 100, separate but in communication with the system 100, or part of another system that is in communication with the system 100. The sensor module 106 can include one or more sensors (e.g., temperature sensor, motion sensor, vibrational sensor, humidity sensor, a RADAR device, a LIDAR device, etc.). The sensor module 106 can be a stationary device (e.g., a sensor attached to a fixture of the marshalling area 116) or a mobile device (e.g., manually controlled, semi-autonomous, or autonomous robot, drone, etc.). Any of the sensor modules 106 can be aerial-based, ground-based, water-based, submersible, etc. The sensor data can be used to augment the camera data. This can be via sensor fusion for example. for instance, a sensor fusion technique can be used to augment or verify identification of an object 118, state of an object 118, change in state of an object 118, assignment of coordinates to an object 118, etc.

In some embodiments, the system 100 can include one or more illumination modules. The illumination module can include at least one light that can illuminate an area 116, a sector of the area 116, an object 118, or provide electromagnetic emission for a camera module 102, etc. The illumination module can include a light sensor to cause the illumination module to activate/de-active the light based on a condition (e.g., ambient light, weather conditions, etc.). In addition, or in the alternative, the illumination module can have a servo that is controlled by the control device 114. A user can control the illumination module via the control device 114 and/or the control device 114 can control the illumination module via program logic, artificial intelligence, etc.

Any of the camera modules 102 can be configured to allow for adjustment of the frame rate. The adjustment can be controlled via the control device 114 or other component of the system 100, for example. For instance, the frame rate of a camera 200 can be adjusted based on activity to control the amount of network traffic and the neural network compute power required to process data. When activity is detected, a higher framerate command can be sent to the appropriate cameras 200 to increase the amount of fidelity of the system 100 to aid the neural network models and the tracker software in providing functionality. Alternatively, higher resolution neural networks may be periodically used to precisely position objects 118 in the area X and then lower resolution neural networks can be used to track moving objects 118.

As noted herein, the system 100 can be part of or in communication with another system 100. Also noted herein is that the system 100 is intended for use in a trucking yard. Thus, embodiments can include a yard management system 100′. The yard management system 100′ can include an embodiment of the marshalling area monitoring system 100 or be in communication with it. The state machine module 104, using the coordinate timeseries log, can be configured to generate a time-in-marshalling area log for an object 118, the time-in-marshalling area log including one or more of: time and location of entrance into a marshalling area 116; time and location of object-in-stationary position; time and location of object-in-motion; and time and location of exit from a marshalling area 116. The yard management system 100′ can include a yard management system (YMS) module 108 configured to transmit and/or receive data, via a bi-communication approach or protocol, to/from an asset management system (AMS) 122.

With the yard management system 100′, the object 118 will typically includes at least a vehicle, and the AMS 122 can be configured to, via a supply chain management technique, manage the vehicle(s) and contents of a vehicle as assets. The YMS module 108 can be configured to compare corresponding data from the AMS 122 to verify accuracy of asset location. For instance, the AMS 122, via the supply chain management technique, can have a record of where and when assets are supposed to be, and this can be compared to data the YMS module 108 receives from the marshalling area monitoring system 100. In some embodiments, the YMS module 108 can be configured to generate an output for updating the AMS 122 or recommending an update to the AMS 122 based on the comparison. For instance, the vehicle might not be where the AMS 122 thought it should be at the time it was supposed to be there (based on the supply chain management technique), and thus the AMS 122 can be updated, as well as the supply chain management protocols, based on the updated information from the YMS module 108. In addition, or in the alternative, the YMS module 108 can be configured to transmit and/or receive data, via a bi-communication approach or protocol, to/from a security system 124. The YMS module 108 can provide the security system 100 with up-to-date information about the marshalling area 116 and the objects 118 therein.

It is understood that data transfer to/from components and systems can be one or more of a push operation, a pull operation, a continuous transmission, a transmission occurring at a predetermined time, an on-demand transfer, etc.

The AMS 122 can be configured to control, coordinate, and/or track vehicle movement and placement within a marshalling area 116. The AMS 122 can have a predetermined staging or parking location for vehicle(s), the vehicle(s) can stage or park at a location that is at a discretion of a vehicle's operator, the vehicle(s) can stage or park at a location dictated by program logic or an artificial intelligence algorithm, etc. This functionality is achieved due to the mapping engine operation discussed above.

In some embodiments, the yard management system 100′ can include an application server 110 in communication with the YMS module 108. The application server 110 can be configured to generate a user interface for display on a mobile electronic device 112 of an operator of a vehicle. A noted above, the AMS 122 can control, coordinate, and/or track vehicle movement and placement within a marshalling area 116. The YMS module 108 can be configured to transmit a message via the user interface to the mobile electronic device 112 based on data obtained via a bi-communication approach or protocol between the YMS module 108 and the AMS 122. This message can inform the operator of the vehicle where to go, where to park, when to unload the contents, that they are in the correct spot or not. In addition, the YMS module 108 can cause the user interface to generate a map of the marshalling area 116 for the operator to follow. This map can be based on the computer vision map generated by the mapping engine.

### EXAMPLES

The following discussion relates to exemplary implementations of embodiments of the systems and methods disclosed herein. It is understood that the following examples demonstrate exemplary implementations, and embodiments of the systems and methods disclosed herein are not meant to be limited to these examples.

An exemplary implementation can include a Yard Vision System. The Yard Vision System includes a series of overlapping cameras configured to capture images and/or video installed around a truck/trailer yard. These cameras are connected to an Edge AI Camera Server that runs deep-learning neural network models. These models identify equipment type, location, and markings. This data is sent to a Cloud AI System that: (a) interprets key data from the equipment arriving on the premises including markings that identify vendor and ID as well as license plate; (b) tracks equipment across all cameras to their final parking location; (c) integrates with other systems or sensors to receive data which further enhances yard data accuracy; (d) integrates with other operational systems like a YMS to augment and correct their data; (e) provides a data visualization of the real-time yard state; and (f) generates alerts based on certain criteria that can be delivered through emails, texts, or other visual or audio means. Additionally, the entire history of equipment's moves and time on the yard is maintained.

Embodiments of the Yard Vision System can include a computer system with a user interface, a database for storing yard inventory data, and a set of modules for performing yard management functions, including camera based Artificial Intelligence modules. The modules include, but are not limited to, inventory tracking, task scheduling, yard status monitoring, and reporting. The system can be designed to improve the efficiency and accuracy of yard management operations, while minimizing the risk of errors and delays.

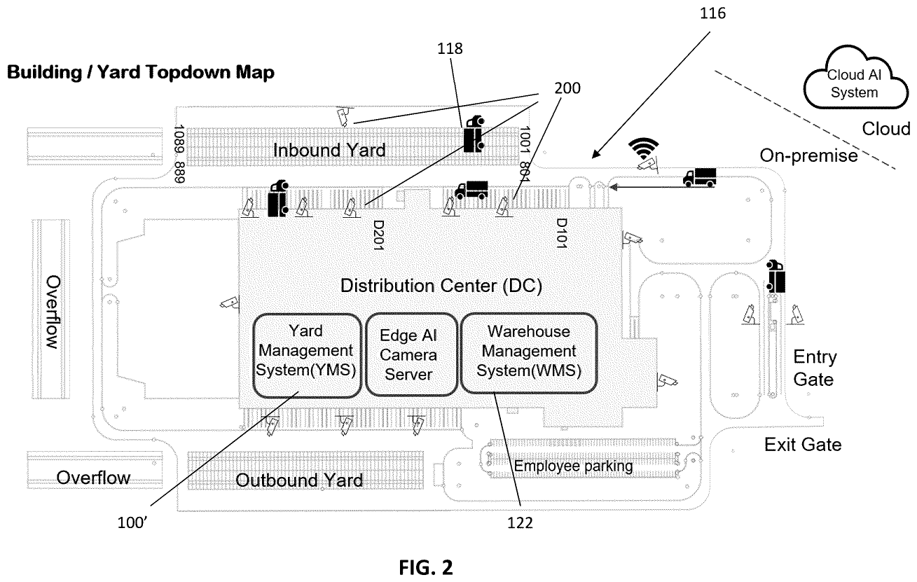

FIG. 2 shows a top-down view of a distribution center and trailer yard 116 with AI cameras 200 and systems to track the operations of the yard according to one or more embodiments of the present disclosure. The distribution center includes the trailer yard 116 and numbered parking stalls for both inbound, overflow, and outbound parking. There are also a series of parking stalls at the distribution center that are numbered dock doors. The distribution center has an entry point or gate for trailer yard. This is the location where tractor-trailers are first seen by the AI cameras 200. There can be one camera 200 that covers each lane entering trailer yard 116. Security guards can be stationed at gate to check-in a driver and their trailer. This check in process can be done to ensure that the driver is authorized, and the trailer load is authorized on the property. The security guard can enter the driver's data and trailer data into a terminal linked to the Yard Management System (YMS) 100′. A parking stall or dock door can be assigned by the YMS 100′ for the trailer to park at. The YMS 100′ and Warehouse Management System (WMS) (or a Asset Management System (AMS)) 122 can work together to decide when the trailer needs to be brought to dock door for unload based upon scheduling and order fulfillment requirements. In this exemplary embodiment, the YMS 100′ includes: a computer system with a user interface; a database for storing yard inventory data; a module for inventory tracking, configured to receive and update inventory data in real-time; a module for task scheduling, configured to generate and assign tasks based on inventory data and user input; a module for status monitoring, configured to track the status of inventory items and equipment in real-time; and a module for reporting, configured to generate reports on yard activity and performance. The user interface allows users to view and manipulate inventory data, assign and prioritize tasks, and monitor yard activity. The inventory tracking module includes features for tracking inventory items by location, type, and other relevant attributes. The task scheduling module includes features for generating schedules based on inventory availability, user input, and other relevant factors. The status monitoring module includes features for tracking the status of inventory items and equipment and generating alerts or notifications in the event of any issues or delays. The reporting module includes features for generating reports on yard activity and performance, including inventory levels, task completion rates, and other relevant metrics.

In this exemplary embodiment, the YMS 100′ is configured to integrate with other operational systems or enterprise resource planning (ERP) systems. The YMS 100′ is further configured to operate on a cloud-based platform, allowing for remote access and scalability. The YMS 100′ includes features for tracking maintenance and repair schedules for yard equipment. The YMS 100′ includes features for tracking and managing yard personnel, including scheduling, and time tracking.

In alternate embodiments there is no security guard at the gate. The driver can enter trailer yard and park and walk into the distribution center and talk to employees responsible for the yard to get the proper location to park. Then, the driver can park trailer at that parking stall and unhook heir tractor and leave the premises.

In some embodiments, the truck driver may use a mobile phone 112 to “self-check-in” to the YMS 100′ by scanning/entering all the appropriate documentation required like the trailer seal number, the trailer and chassis info, the driver's license, bill of lading for the trailer, etc. The mobile device 112 can then tell the driver where to park and may provide a map to trailer yard.

In some embodiments, there is no YMS 100′ at the distribution center.

With any embodiment, a series of overlapping power over ethernet (POE) cameras 200 can be used to overlook trailer yard with non-obstructed views of all parking spots and the driveways around the yard. These cameras 200 can provided Axis Communications cameras with camera model P3818, for example, that provide very high resolution and very wide field of view images of trailer yard. It is understood that other cameras 200 may be used and may have solar power/batteries/lights/WIFI and or 4G/5G network connectivity to the cloud or on premises switches/servers. Any of the cameras 200 can be connected to an Edge AI Camera Server. It is contemplated for the Edge AI Camera Server to run artificial intelligence/deep learning to read and track tractor-trailers as they enter/exit and move across the trailer yard. The Edge AI Camera Server and optionally the existing YMS 100′ can connect to the Cloud AI System using secure wired or wireless internet connections. Together the Edge AI Cameras 200, the Edge AI Camera Server and the Cloud AI System, collectively the Yard Vision System, visually track tractor-trailers to create an accurate transaction log of all events happening in the yard.

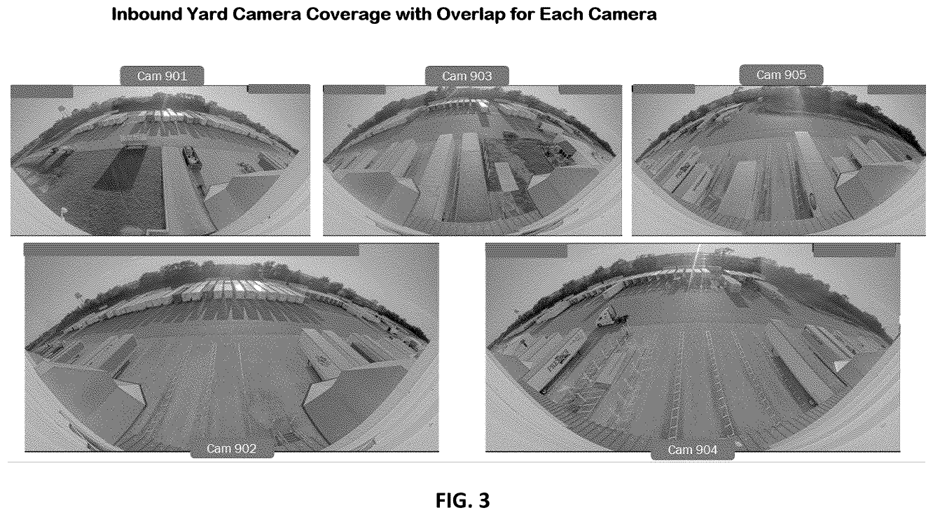

FIG. 3 shows a series of five overlapping cameras 200 attached to the distribution center outside wall overlooking the trailer yard. These Axis P3818 cameras are 2:1 aspect ratio that allow a very wide field of view up close to the distribution center dock doors and overlooking multiple rows of parking stalls. It is important that the cameras have non-obstructed views of all trailer tops in all areas of the trailer yard. With continuous overlapping cameras that have complete coverage of the trailer yard the Cloud AI System can properly track movement from one camera to the next. Alternatively, the cameras 200 may need to be remotely placed away from the building to ensure complete coverage of the trailer yard. In alternate embodiments, the cameras 200 do not need to overlap to link trucks leaving one camera's 200 field of view and entering another camera's 200 point of view.

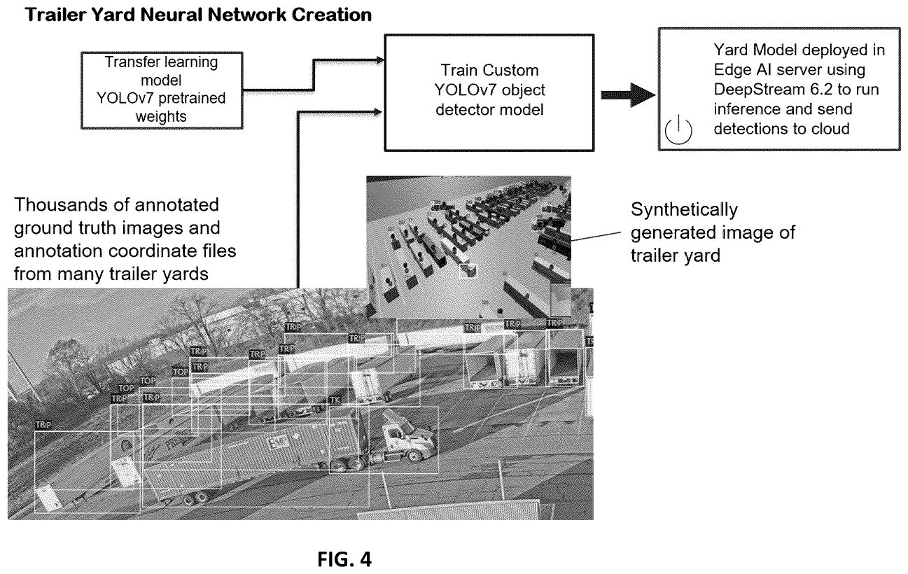

FIG. 4 shows a drawing showing how the YOLOv7 object detector is trained such that the Edge AI Camera Server can track all the objects for each camera 200. Trailer, top and yard jockey, vehicles, human, etc. classes are annotated by drawing rectangles round their outer extents. A file can be generated for each annotated image that has the class name, x1,y1,x2,y2 coordinates of the bounding rectangle for all objects in the image. YOLOv7 object detection is a state-of-the-art deep-learning technology used to look at an image from a camera and find all objects that it has been trained to detect. The training begins with a transfer learning YOLOv7 pretrained weight file that is published by creators and users of YOLOv7. This transfer learning model is a good starting point to train the custom YOLOv7 object detection model. Leveraging transfer learning is a proven way of increasing neural network accuracy and speed of training. The next step is to capture thousands of images from various cameras 200 installed at this and other trailer yards. It is important to get many different pictures that have different daytime and night-time lighting conditions, different weather, different types of tractor-trailers, trucks, containers, humans, other vehicles, different rotation poses of trailers moving throughout the trailer yard. Once these pictures are collected then a human annotator draws rectangles around the various objects seen in the images using an image annotation tool. Tractor-trailers components can be: trailer tops, trucks of the trailers, trailers and yard jockey vehicles, cars, humans, etc. Care must be taken that these rectangles are very accurately positioned on top of the object bounds. For each human annotated image, the annotation software provided by vendors like SuperAnnotate will create a text file for that image with all of object classes, the upper left rectangle X coordinate, the upper left rectangle Y coordinate, the lower right rectangle X coordinate, the lower right rectangle Y coordinate, etc. These thousands of images and their corresponding annotations text file can be uploaded into a training project for the custom YOLOv7 object detection mode. The training process outputs a custom Truck Yard neural network model. This model is converted to a Tensor RT format that can run in DeepStream 6.2 from NVIDIA corporation. It is then be deployed to the Edge AI Camera Server. In alternate embodiments, YOLOv7 pixel Instance segmentation models may be used verses object detector rectangle models. There are many publicly available neural network training models other than YOLOv7 that can be used.

In some embodiments synthetically generated images can be used to augment the real image ground truth. These can be created by 3D modeling/simulation tools like Unity3d, NVIDIA Omniverse, etc. These environments can model simulated trailer yards, camera positions, camera characteristics, lighting, weather, and color of trucks/trailers/containers. The pose orientations of all objects can be dynamically changed by these simulation tools. Then, images and their respective annotations can be generated automatically to augment the real images taken from cameras 200 placed over the trailer yard. Also, generative AI images can be created just by asking the generative AI platform to create simulated images of trucks/trailers moving around a simulated trailer yard after providing it with several sample images. Image Augmentation techniques can also be employed to increase the robustness of the ground truth used for training. All these image generation techniques can be used to generate more ground truth to train the neural network to improve overall accuracy of the network. These 3D simulation worlds can be used also to test the production Yard Vision System with many thousands of different types of yard animations that may be difficult to capture on a live camera-based system. Periodically, new images from each trailer yard can be captured when object detection confidence levels become low. These can then be added to the groundtruth to train the network. In this regard, a continuous improvement system can be implemented.

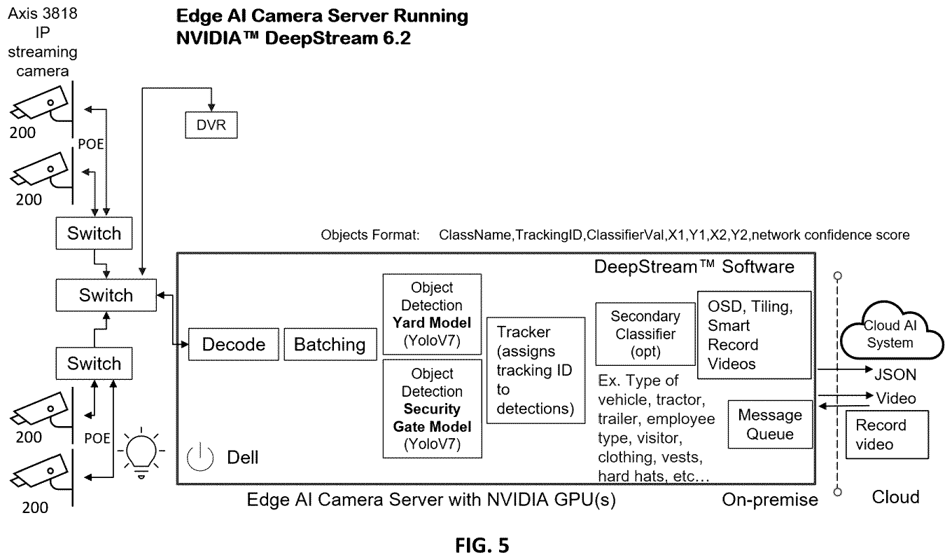

FIG. 5 shows a series of cameras 200 connected using POE switches with Category 6 ethernet cables and fiber optic cables to an Edge AI Camera Server running NVIDIA DeepStream™ (https://developer.NVIDIA.com/DeepStream-sdk) and custom neural network models used by an embodiment of the application. In alternate embodiments, wireless cameras 200 may be used. The Edge AI Camera Server can be any commercially available server like Dell, HP, NVIDIA hardware. The requirement is that it has a CPU, Memory, Storage and at least 1 NVIDIA GPU (graphics processing unit) core to run the Neural network models. Embedded hardware like NVIDIA Orin, Xavier, Jetson processors may also be alternatives as the Edge AI Camera Server.

A sample JSON Objects Message can be:
“json_version”: “1”,
“cameraID”: 903,
“timestamp”: “2022-12-21T16:01:05.848Z”,
“sensorName”: “DC_0499_0902”,
“objects”: [
“TOP |132 |0 |6452 |2171 |6992 |2671 |0.98”,
“TRAILER |134 |0 |6450 |2164 |6993 |2968 |0.96”,
“TRUCK |133 |0 |2576 |4021 |4408 |9650 |0.98”,
“TOP |129 |0 |6700 |4074 |7987 |6160 |0.98”,
“TOP |131 |0 |428 |4790 |880 |5420 |0.98”,
“TRAILER |130 |0 |1912 |4195 |3103 |6382 |0.98”, . . . .

In alternate embodiments, object detection networks can be ran inside each IP streaming camera 200 and those cameras 200 directly communicate to the CloudAI System. It is contemplated for the NVIDIA DeepStream to be a package of software that allows the video from the cameras 200 to be decompressed or decoded from H264 or H265 into the raw format appropriate for GPU memory.

Next, the frames of video in GPU memory can be passed in batches to the appropriate neural network model running in the GPU. The output of these neural network models can be classes found (e.g., Truck #1, Trailer #3, Trailer Top #72, etc), the rectangle coordinates for the class on the camera image, and the neural network confidence score (0-100%) on how accurately the neural network thinks it is on the detection. This data can be passed by DeepStream to the tracker software that gives an integer for that same object as it moves or is stationary from frame to frame of the video. It is contemplated for the tracker to be publicly available software on GitHub called ByteTrack. DeepStream provides alternate trackers called NcDCF, NVSort, Deepsort, and IOU. However, any tracker or a custom-built tracker can be used to associate the same neural network object detections from frame to frame of the same video.

Optionally, a second stage object classifier can be used for further classification of the objects detected. One non-limiting example can be a trailer vendor classifier be used to further classify which trailer vender from a list of vendors (Fed EX, Maersk, UPS, CFI, local delivery, local service truck, etc.). This can be an aid to separately track which tractor-trailers are passing each other or driving next to each other across multiple cameras 200. These other types of vehicles typically do not park in approved parking spaces, but their current position and entire move history can still be monitored in the yard by aforementioned tracking system.

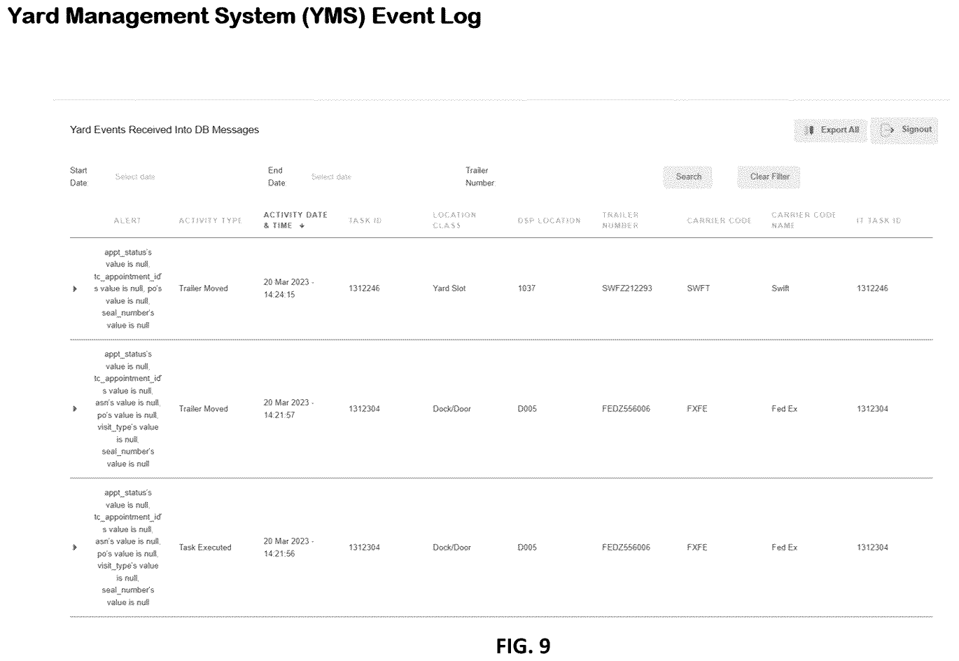

Another non-limiting example can be classifying what type of person is walking (e.g., manager, service technician, red vest, blue, orange vest, hard hat, security uniform, etc.). These classifications of the type of person allow the tracking system to determine if a person is in an authorized location in the yard (e.g., a safe walking zone). When safe to walk regions of interest locations (see FIG. 9) are compared to the human position then determinations are made to send alerts to management personnel and loudspeakers and lights on the building announce that this is an unsafe position for the person to be walking. Video recordings of the event are taken. These alerts are configured by employee type. For example, a manager or security personnel may be allowed to go in unauthorized areas (regions of interest) without setting off an alert. A truck driver may be able to exit their truck to walk into a safe walk zone or open their trailer doors and not set off a trigger. But if that person strays into unsafe zones, then alerts may be sent. Alerts may or may not be triggered if a person is walking in an unsafe zone as long as no moving vehicles are in the vicinity. Human-to-vehicle and/or vehicle-to-vehicle collision or near-collision alerts and recordings can be sent as well.

A message queue can be provided, so the Edge AI Camera Server can send JSON messages to the Cloud AI System. These messages for each frame of each camera 200 can contain the following information: CameraID, TimeStamp, Camera Name, Object Detections found on this frame. This can include the coordinates of these objects and the confidence score of the neural network models as well as the trackingID for each object is sent. The cameras 200 can be run at 5-10 frames per second and there are many object detections per frame. If no objects are detected for a short period of time, a heartbeat message can be sent to ensure the message queue is kept alive from the Edge AI Camera Server to the Cloud AI System. The advantage of this JSON messaging system is that a very small amount of data needs to be sent out to the cloud which keeps network bandwidth costs low. The Cloud AI System determines if a video of any event should be recorded and sent to the cloud. A non-limiting example can be when the truck drives through the gate and the Security Gate model outputs the BACK of a trailer that has been detected, then the Cloud AI System can send a record event to capture the tractor-trailer entering the yard. Alternatively, when a driver parks in the wrong parking spot a video request can be made about the mis-park and the driver and Yard Manager can be notified and shown the video to correct the error. These videos may be annotated with objects detected, their tracking numbers, timestamps, YMS instructions, etc. to aid in error resolution. Software DeepStream™ can allow these video effects to be done to the video.

A smart record process inside the software can store a circular memory of each camera 200 for the last three minutes. Thus, when the Cloud AI System asks for a video, it can ask for any time back three minutes to anytime in the future to completely capture the event. The advantage of this system is that only key events need to be recorded and sent off premises to save bandwidth and storage costs. These videos and images extracted from them may be used in web reports and sent to key stakeholders who need them. Safety violations of personnel and vehicles may also cause a record event to occur, so this can be shown to facility management for corrective action or real-time security alerts can be announced through speakers or other messaging to specific parties. Also, these videos can be used to augment the images used for neural network training to continuously improve the neural network models.

The Axis 3818 cameras 200 can stream to a DVR recording service as well as to the Edge AI Camera Server. Thus, these same cameras 200 can be used for Surveillance/Security and Cloud AI System functionality. The Edge AI Camera Server may become or be integrated into a security surveillance software system to track all security and safety events not limited to: unauthorized vehicles, personnel, truck-trailer tampering, too fast of yard driving, collision or near collision events, open trailer doors, etc. This type of data may trigger alerts to security or Distribution Center personnel, police, or robots to remedy.

Axis P3818 POE cameras 200 can have on board heaters and temperature sensors. These systems can be monitored by the Cloud AI System or Edge AI Camera Server using the AXIS camera API and have the on-board heaters turned on to de-fog or dry the camera lens cap or to keep the camera warm during freezing temperatures. External weather portals can also be monitored to trigger the heater based upon actual or expected weather in the area. The temperature sensor can be used to assess the average overall temperature in the trailer yard for a refrigerated or non-refrigerated trailer that has been parked in a trailer yard for a period of time. Once temperature/time thresholds are determined the distribution center personnel can be alerted that something must be done to cool the contents of that specific trailer such as moving the goods into the distribution center to avoid damage or spoilage. These cameras 200 can have speakers as well and based upon triggering events can alert drivers or yard personnel that safety or security violations have occurred and give parking instructions or error alerts.

It is contemplated for the Edge AI Camera Server to be hosted off premises in the cloud or other location, but it need not be. In this case, the camera videos would be streamed to this offsite system and the Edge AI Camera Server functionality would run there. The object detection Security Gate model may be run in the cloud or off premises. For instance, a motion activated camera 200 can record a raw short video of the truck driving by the gate and send the video to the cloud for inferencing there. In some embodiments, neural network models could run inside intelligent cameras 200 and JSON messages or other message formats may be sent directly from the intelligent cameras 200 to the cloud. These cameras 200 may be wirelessly connected to a wired internet connection or leverage 4G and 5G mobile cellular networks. Illumination for the cameras 200 and neural network models can be important. Thus, use of visible/IR lights for the trailer yard or gate can be used. These lights may turn on/off at dusk/sunrise or be motion or neural network activated.

In some embodiments, the cameras' 200 frame rate may be dynamically changed to control the amount of network traffic and the neural network compute power required to process the data from multiple cameras. When trailer yard or gate activity is detected, then the higher framerate command can be sent to the appropriate cameras 200 to increase the amount of fidelity of the system to aid the neural network models and the tracker software in providing the Cloud AI System assisted functionality. Alternatively higher resolution neural networks may be periodically used to precisely position objects/trailers in the yard and then lower resolution neural networks can be used to track moving objects. In one embodiment, one camera 200 and its object detections can trigger a record event at another camera 200. Then the recorded movie of the tractor-trailer entering or exiting the trailer yard can be inferenced in the cloud or on premises to read the appropriate data off the tractor-trailer (e.g., Trailer number, SCAC (Standard Carrier Alpha Code), license plate number, trailer vendor number, chassis number, etc.). Thus, the system 100 can be an intelligent smart record/motion detection system—e.g., it can be configured to only turn on the record event when the correct type of vehicle passes by the camera 200, whereas other vehicles or motion can be ignored.

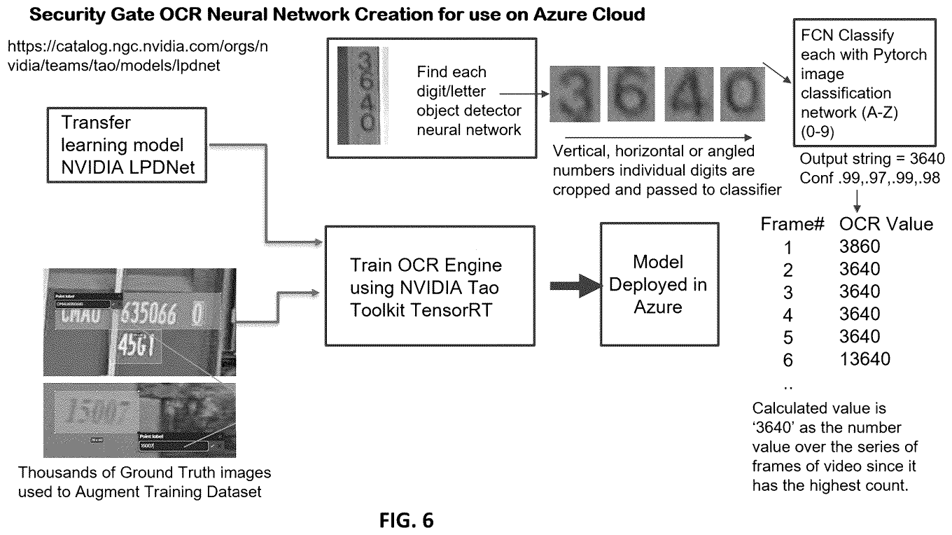

FIG. 6 shows how an Optical Character Recognition (OCR) system can be created and deployed to the cloud. This OCR system can be responsible for reading numbers, words, license plates and other data off the trailers, containers, trucks, and cars that pass through the gate. There are many publicly available license plate readers used at parking lots, on freeway toll lanes, by police and elsewhere in the commercial and government environments. Trailers and containers have uniquely difficult lettering since there is very little standardization in fonts, font size, color of font, color of trailer, position, orientation, etc. Camera 200 position, lighting, and weather conditions affect the quality of the OCR reading. What is needed is a neural network that improves upon public domain system to consider these variations. NVIDIA™ provides an LPDNet neural network transfer learning model as part of its DeepStream development platform for enterprises to build intelligent license plate reading applications. Using the Tao Training Toolkit as part of this platform, the public domain model can be augmented with trailer/container specific ground truth from actual yard cameras at gates. Many thousands of images of trucks/shipping containers can be human annotated with the bounding boxes for the numbers on the trailer—typically, on the backside of the trailer. These bounding boxes can be detected to allow the system to crop out these numbers and provide them as additional ground truth to the Tao Training Toolkit. Human annotators can enter the numbers that they see in the rectangle into a field in the annotation tool. Both the cropped number and the value of the alphanumeric can be provided to the Tao Training Toolkit. Then, the neural network training process can leverage the transfer learning model provided by LPDNet and improve upon it using the application of specific ground truth. Once the model is created, it can be deployed to either the Edge AI Camera Server or the Cloud AI System. Then, at inference time the numbers can be read off the trailer/container and require no human intervention to read the numbers. In alternate embodiments other public domain or licensed OCR systems can be utilized in addition to or in lieu of the aforementioned techniques. This OCR reading is a rapidly evolving field of discovery and multiple firms are working on improving number reading that works in many applications.

In alternate embodiments, third party services or software can be sent still images or videos of tractor-trailers driving through the gate and those services can provide the various alphanumeric values required for the Cloud AI System functionality.

Vertically orientated numbers are especially difficult to read by existing OCR engines. With embodiments of the disclosed system 100, however, for vertical or horizontal numbers on trailers/containers the OCR engine can find each digit/letter in the vertical number using a custom yolov7 digit/letter object detector trained to find individual digits/letters in images. Then, these digits/letters can be cropped out of the source image and sent to a custom alpha-numeric FCN image classifier created in PyTorch. The output of the image classifier module can be the confidence level that an image contains a specific digit or letter. The software can then combine each digit/letter into a total trailer number string used for reports. A series of camera frames from the trailer entry video can be used. This provides the OCR software multiple chances to classify the entire number from different vantage points of view. The outputs of these series of images can be compared to get the most likely classification of the entire string of letters/digits. The digit/letter object detector can be trained in yolov7 using thousands of annotated images of rectangles around each individual digit/letter contained. The Pytorch FCN trained image classification network was trained with thousands of individual letters/digits in their respective 36 folders (A-Z)(0-9). The Pytorch FCN number/letter classifier is trained with t of characters captured off the back of trailers/containers in various positions, poses, lighting, weather, fonts, sizes, colors. Image augmentation and synthetic images can be used as well to make a robust classifier.

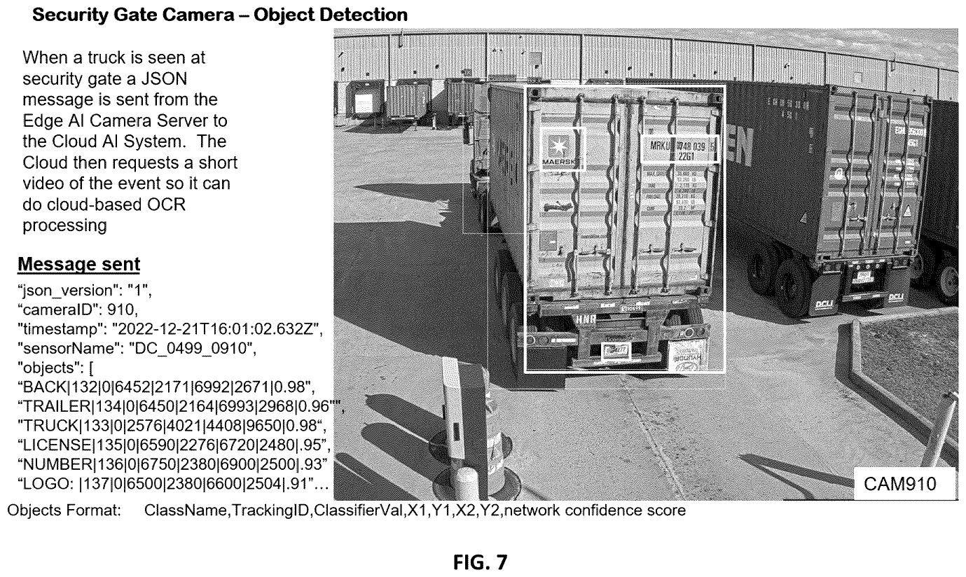

As the trailer drives through the security gate, the numbers and license plates can be read over a series of frames of the video. Some inferenced OCR numbers may be wrong and some may be correct based upon what the human eye can determine. The table in FIG. 6 is the list of OCRs values collected over the series of video frames. The errors are based upon many factors like lighting, angle of camera to the alpha-numerics, distance from camera, weather effects, and the rectangle coordinate accuracy of the License or Number neural network etc. The software can determine which Alphanumerics match from frame to frame of the video or are similar and the quantity of the matches to get the highest confidence of what the actual number is seen on the vehicle. If for example, the trailer number ‘3640’ is read on 4 frames and ‘3860,’ is read on only 1 frame of the video then the number ‘3640’ is highly likely to be the trailer number since it is read many more times than the others numbers read by the OCR engine. The low frequency OCR digit reads can be dropped. Also, the Levenstein distance formula can be used to even further link similar numbers together to get the highest accuracy of the trailer or license numbers. For example, in video frame number 6 in the table in FIG. 6 is ‘13640’. This number has an extra digit “1” in the front of the actual value of ‘3640’. The Levenstein algorithm can be used to determine that this is actually ‘3640’ and will increase the total count of ‘3640’ to 5. The list of highly occurring numbers can be listed on the web report FIG. 7 and messaged to exiting YMS systems or compared against YMS systems data collect by the security guard at entry time. When neural network confidence scores are returned with entire numbers or characters, the software can make a decision to send the number to a human for verification if the confidence is below some threshold. The human can correct any mistake in the Cloud AI System. Alternatively, the OCR inferenced number can be validated against the data provided by the existing YMS. Either system can update/correct the other. When low confidence scores are found, the images can be added to the respective neural network ground truth to perfect the OCR neural network engines over time.

FIG. 7 shows a tractor-trailer driving through the gate. The Security Gate model inside the Edge AI Camera Server can perform object detection to find the various components of a tractor-trailer (trucks, trailer, back, numbers, license, logo, etc.). These detections can be formed into a JSON message by the Edge AI Camera Server. These messages can then be sent through the message queue to the Cloud AI System for further processing. The Cloud AI System can send a video request message to the Edge AI Camera Server. The Edge AI Camera Server can send the short video to the Azure cloud storage and send the video's URL to the Cloud AI System using the message queue. Then, the Cloud AI System can perform object detection and OCR on the trailer to identify all key elements required for the Cloud AI System functionality. Also, the best OCR image can be taken from the video and sent to the web report dashboard and to distribution center employees as needed.

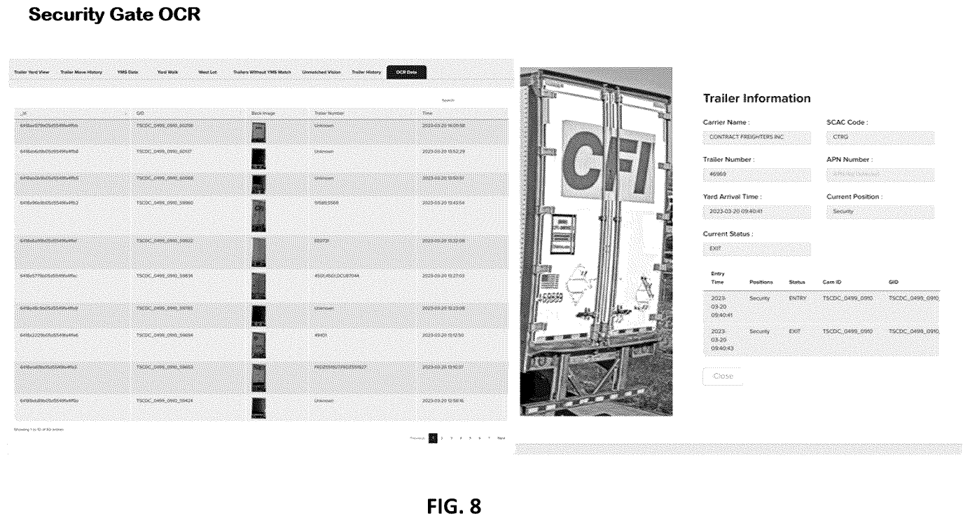

FIG. 8 shows a web portal illustrating all the trailers that enter the facility and the OCR that has been done on the BACKs of the trailers.

When the Cloud AI System sees JSON messages sent from the Edge AI Camera Server that a truck is at the security gate, it can request a short video clip from Edge AI Camera Server of the moving truck. The video can be sent to Azure cloud storage and then the same object detector can be ran against it to find the license plate, logos and numbers. Then, they can be cropped out of each image and sent to a custom OCR reading neural network and classifier networks for analysis. High confidence alpha-numerics can be entered into the trailer number field if no YMS data exists, or the recent YMS events entered in to the YMS by a human at the security gate are compared to match what the vision system saw.

Each trailer entering can be timestamped, can have a GID (global ID) assigned to it, and can have the image of the truck driving through the gate. The image can be extracted from the video that was uploaded by the Edge AI Camera Server to the Cloud AI System storage bucket. The image that is extracted can be the one that returns the highest confidence score for the numbers on the back of the trailer. A detailed web page can be shown for the trailer that is selected by the user. This can be configured to show the carrier's name, the SCAC code read from containers, the trailer number, the APN number, the yard arrival time, the current position, the current status of the trailer if it is still at the location or has just left. Also, a time stamp of when the tractor-trailer completed the check-in and drove into the yard can be generated. The various numbers shown can be read by the OCR system in the Cloud AI System. Also, neural network classifiers can be used in addition to OCR engines to read the tractor-trailer carrier name and then map the cropped logo image to a character string of the carrier's name. The OCR system and Cloud AI System can also compare the OCR generated values to the data provided by the existing YMS. The existing YMS may provide the information several minutes after the tractor-trailer has already left the gate. Discrepancies between the data collected by the two systems can be automatically found and corrected on one or the other system. There can be a camera 200 located on top of the distribution center to oversee the security gate, so precise correlation of security gate trailer tracking ID and camera trailer tracking IDs can be determined by timestamp of entry and exit. The software can perform a letter by letter comparison for the Cloud OCR returned values and the existing YMS returned values. Alternatively, a human Yard Management employee or other human may be asked to validate which values are correct and make the updates to the appropriate system.

FIG. 9 shows a web page with data sent in from the existing YMS 100′ if one is utilized at the distribution center. This data can be collected by a security employee and is manually entered into the YMS 100′ several minutes after they confirm the drivers identity, their authorization to bring the trailer onto the trailer yard, read relevant values off the bill of lading, driver's license, and the trailer including but not limited to: the trailer number, container SCAC code, security tag identifier, carrier code, carrier code name, the location class of this event, the activity type, etc. These can be fields sent in from the customer YMS every few minutes to the Cloud AI System for matching to what the vision system saw at approximately the same time. The YMS 100′ can determine where the trailer should park and assigns a parking location where the trailer should park. Unique TaskIDs can be created by the YMS 100′ to keep track of this specific entry of a trailer into the trailer yard. This data can be received by the Cloud AI System. Cameras/mobile phones/wireless devices can optionally be used by the employee or truck driver to capture data automatically and send it to the YMS 100′ and then sent to the Cloud AI System 100.

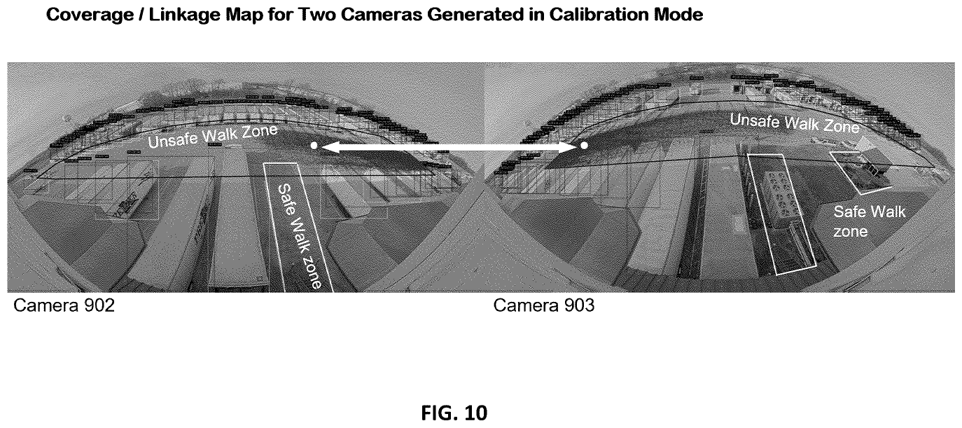

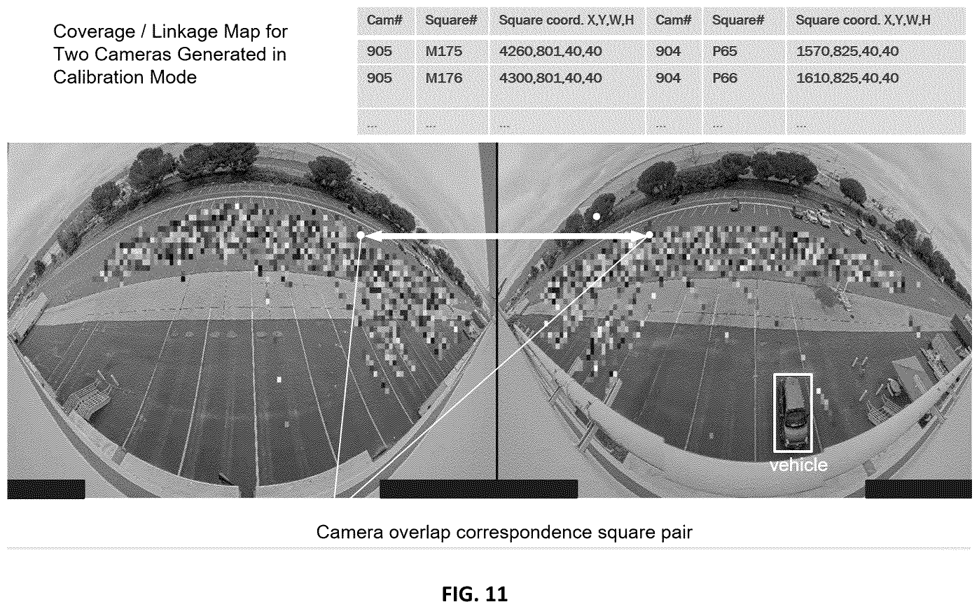

FIG. 10 shows the camera overlap coordinate map for two camera 200 in the yard. This can be used to do an automatic mapping of the trailer yard for camera calibration purposes. This map was generated by using the data from the JSON message sent from the Edge AI Camera Server to the Cloud AI System. Data can be collected for a calibration period (example: one week). Solitary trailer-TOPs that move between the two cameras 200 can be found and their center X,Y coordinates for each frame of video for each camera 200 can be logged to a database record. The trailer top center point coordinate can be used verses the rectangle outer coordinates returned in the JSON message. This collected data is shown as individual dots pairs on the respective camera images. For each point on one camera 200 there can be a corresponding point on the other camera 200. This point cloud image helps determine if enough data is collected over the calibration period. If not, then the calibration period can be extended, or the customer can be asked to drive a tractor-trailer through those regions. This process can map a direct coordinate on one camera 200 and associate it to a corresponding coordinate on another camera 200 for the same moving object. Many tens or hundreds of thousands of corresponding point pairs can be collected during the calibration period for each set of adjacent cameras 200. A database table can store the data in the following format: Cam#a,xa,ya, Cam#b,xb,yb. The xa, ya are the x,y centerpoint coordinates of the moving trailer-top on the first camera 200 and xb,yb are the x,y coordinates of the same moving trailer-top detected on the second camera 200. Human annotators may be required to periodically validate that the two trailers-tops are the same but shown on different cameras. A visual tool allows these annotators to confirm the linkage by watching these points moving across the two screens. No actual live camera video is needed to do this process. The goal of this mapping is to be able to link a trailer top tracking ID from one truck on one camera 200 to another trailer top tracking ID on another adjacent camera 200. With this linkage the entire journey of a trailer from the gate through the trailer yard can be tracked. The individual points can be mapped into a grid of 40×40 pixels across the entire image (see FIG. 11). There is a small square on one camera 200 that maps to a specific square on another camera 200. So, if the center of a trailer is seen by the object detector in one square on camera 200, then there should be the same trailer in the corresponding square on another camera 200. Using this technique, the software can handle tracking ID linkages as a tractor-trailer moves from one camera to the next camera 200. In this technique, no regression neural network is needed. Rather, a simple lookup table can be used by the software to compare trailers on one camera 200 with trailers on adjacent cameras 200.

FIG. 10 also shows safe walk zones and unsafe walk zones for humans or employees. Precise yard world coordinates (feet,meters,longitude,latitude . . . ) of trailer yard keypoints can be used by the Cloud AI System to map every parking spot relative to each cameras field of view and these real world coordinate keypoints. The lines painted on the ground can be ideal for world coordinate mapping and/or fixed facility items like firehydrants, buildings, lamp poles, etc. These coordinates can be captured by a site surveyor and using satellite images from Google earth or similar service. Keypoints on each camera 200 can be associated with these world coordinates. Homographic projection mapping techniques can be used to find the distance of any tractor-trailer to any of these keypoints. Topdown Distribution center maps can show the position, trajectory of each moving vehicle or object in the yard. This data can be used to associate the same objects on different cameras. This is so the entire journey of the tractor-trailer can be tracked from the security gate, throughout the yard and to the exit.

For FIG. 10, during automatic yard calibration mapping each moving truck-top center x,y coordinate in one camera 200 can be mapped to a corresponding truck-top center x,y point in another camera 200. Point cloud images can be generated over several days of trucks moving around the yard (see image) to aid in determination that enough yard activity has been tracked. Each adjacent camera pair can have the same type of mapping learned during yard training. (e.g., 903/904 and 904/905). Humans may be used to validate the correspondence data. These camera correspondence points can be mapped as follows Cam#a,xa,ya, Cam#b,xb,yb. Many hundreds of thousands of these points can be “learned” over the training period, and then a neural network can be trained with this data to infer “missing points” for this overlap region for each camera. At inference time, the software can send the camera number and truck-top center for a moving truck on each camera and the neural network can return a confidence score that the two locations match. If, over successive frames, the average confidence passes a threshold value then the trucks can be linked as the same truck.

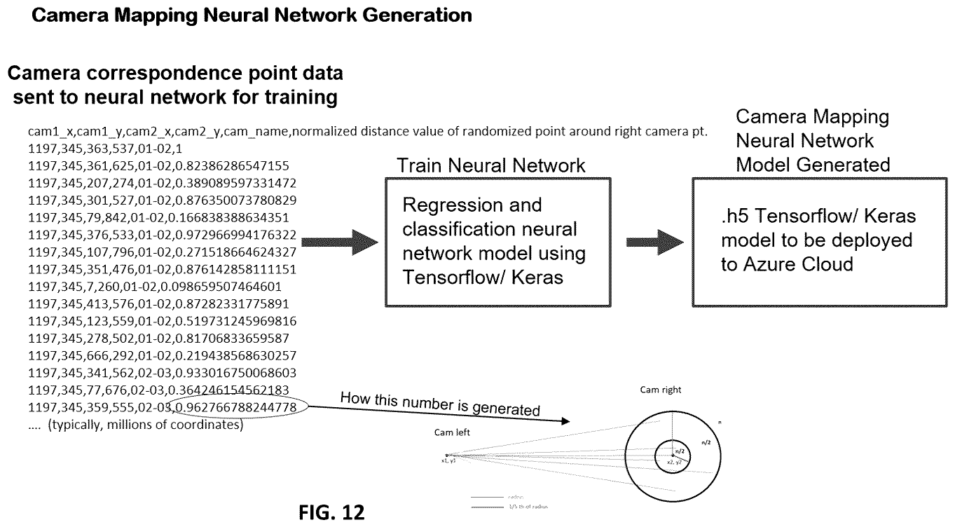

FIG. 12 shows how the adjacent camera 200 correspondence-points collected in the calibration period across all cameras 200 can be used to train a regression and classification neural network. The adjacent camera correspondence-points can be fed into a mathematical routine that creates a normalized distance value of randomized points around the right camera 200 of the camera pair.

The floating point number can be calculated as follows:
dims of cams=2560×1280
r=radius=500
n=number of points=50
   Define a circle with radius r around right camera point [circle with green radius]
   We create 50 random points inside & outside the r radius circle
   Within the r radius circle, we have inner circle of radius=⅕*r [20% of radius] [circle with blue radius], to define close proximity to the point.
   Within the r/5 radius circle, we have n/2 points [red rays] & the other n/2 in the outer area in between radius r/5 to r [blue rays]
   The output value inside the rcircle is 1—normalized distance of random point & center, which pertains to the similarity of the points
   The output value outside the rcircle is 0

Once all these six fields are calculated then the regression and classification neural network can calculate the rest. The training network can calculate angles and distances between different points pairs relative to each other on their respective cameras and combine this with the camera correspondence-point table data to feed the training network.

Then all these data variables can be used to create the Tensorflow Keras regression neural network model with custom cost function to optimize the model. When the training network is complete, the model can be deployed to the Cloud AI System. This model can be used to see if two trailers seen on adjacent cameras are the same trailer. The output of the model can be a confidence score (0.0-1.0) when provided the coordinates of moving trailers. This confidence score is a percentage likelihood that the trailers are the same trailer on the adjacent cameras 200. Once a predetermined threshold is met (for example 90%), then the trailer tracking IDs can be associated from each separate camera into the Global Tracking ID for that trailer.

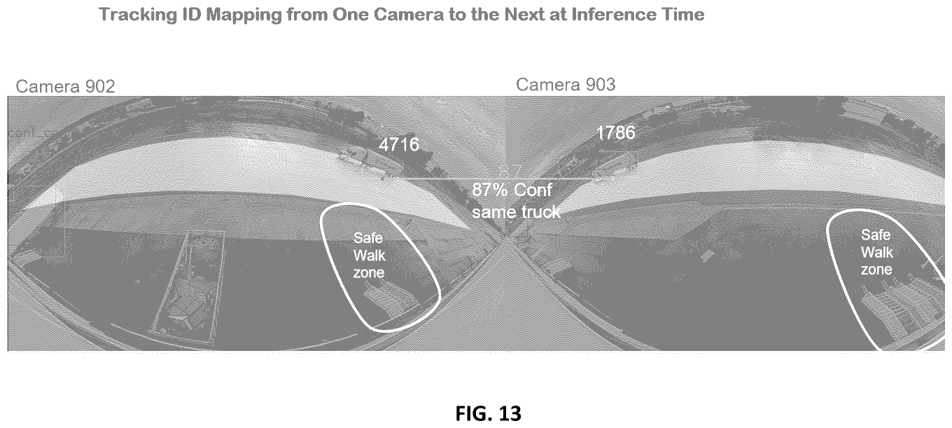

FIG. 13 shows the same tractor-trailer shown on two overlapping adjacent cameras 200. At runtime, a moving truck-top tracking ID #4716 in a camera 200 can found. Adjacent cameras 200 can then be checked to see if they contain a moving truck. A moving truck-top tracking ID 1786 in another camera 200 can be found. Both sets of coordinates can be sent to the Camera Mapping Neural Network model that returns with a confidence (e.g., an 87% confidence) that they are the same truck. The trucks direction, trajectory, and/or speed can be used as well to sort multiple trucks in same region. Then a global tracking ID (GID) can be created to link the trucks journey across all cameras—e.g., Cam2, TracID 4716, Cam3,TrackingID 1786,Global tracking ID H42Z337Q1.

Each camera 200 can have the inference done by the Edge AI Camera Server. All trailers, trucks, trailer tops can be found by the object detection model. The tracker software can assign a unique tracking ID to each object on each camera. It attempts to keep the same tracking number for the same object over successive frames of the video for that camera. In the camera 200, a white truck is moving from the right side of the screen towards the center of this camera. It has been assigned a trackingID of 4716. The same white truck is moving from the center of another camera 200 towards the left side of the first camera 200. It has been assigned a camera specific tracking ID of 1786. The centerpoint coordinates of each Trailer or TrailerTop rectangle is passed to the CameraMapping Neural network in the Cloud AI System. The format of the data is cam902_centerx, cam902_centery, cam903_centerx, cam903_centery. The neural network can return a confidence score from 0-100% that the moving trucks are the same trucks. A low number denotes that there is low likelihood that the moving trucks are the same. A high number (ex. 0.99) is a 99% confidence they are the same moving truck. After several successive video frames are collected the average confidence score is generated. If they are above some threshold (for example 95%), then the individual tracking IDs are associated with the GLOBAL tracking ID assigned when the truck enters the trailer yard. In this case, the Cloud AI System stores the camera specific tracking IDs 1786 and 4716 to Global Tracking ID H42Z337Q1. This same process can be replicated for the trucks move across all cameras in the trailer yard. Thus, a linked list table of all camera 200 specific tracking IDs are associated with one Global ID H42Z337Q1. That Global ID is now linked to all the Trailer Information. Thus, wherever the trailer finally parks the entire trailer information, details and travel journey have been linked together in the database. When multiple trucks are passing each other and are seen on both cameras, the centerpoint coordinates of each truck on one camera can be tested to the centerpoint coordinates of each truck on the other camera using the camera mapping neural network model. Then, each combination is compared to find the highest confidence score match. For example, if there is trailer ID1 and ID2 on the camera 200 and trailer ID3 and ID4 on another camera 200 then trailer ID1 and trailerID4 may be linked to the highest confidence verses trailer ID1 being linked to trailer ID3. This system can allow for many passing trucks to be linked properly due to their highest confidence score. This same system can allow for tracking human and other vehicle types across cameras 200.

With the above process, rapid yard automatic learning and calibration of spatial data relative to tractor-trailers moving across each camera 200 can be achieved. No yard measurements are needed to be taken unless otherwise desired.

In an alternate embodiment, the Camera Linkage Map shown in FIG. 11 can be utilized. The table has each camera image broken up into 40×40 pixel square blocks in terms of X,Y coordinates. When a trailer or trailer top is found by the object detector on the camera 200 at center X,Y position 4265,807, then this maps to at Linkage Map coordinate M175. Then the software determines if there is a trailer or trailer top seen on another camera 200 at coordinate P65 (1570,825,1610,865 pixel coordinates). If there is a trailer there per the object detector, then the Tracking IDs are linked from each camera 200 into the global ID as shown in FIG. 13. This Coverage Linkage map table provides a quick lookup table for software to check the XY coordinate of the trailer in one camera to find its corresponding Calibration square on the other camera.

In alternate embodiments, other spatial tracking technologies can be employed when multiple overlapping cameras 200 are used. The Axis P3818 camera used by the invention has a very curved lens since the camera has such a wide field of view. This wide field of view can make the more traditional homographic projection mapping difficult. This homographic technique uses a real-world coordinate system for the yard and each camera pixel is mapped to that real world coordinate system. Then, the trailers real world position can be determined to link the same trucks across overlapping cameras 200. Many techniques like projection mapping are well published and well researched by universities for over the past 30 years. Web searches for “Multi-Object tracking using multiple overlapping cameras” will find many of these papers. These other spatial tracking technologies can also be used to link one tractor-trailer on a camera 200 to the same tractor-trailer seen on another camera 200. In other embodiments, re-identification neural networks can re-identify specific trucks as the same trucks as they move across cameras 200. This is like the way biometric systems re-identify the same person from camera 200 to camera 200.

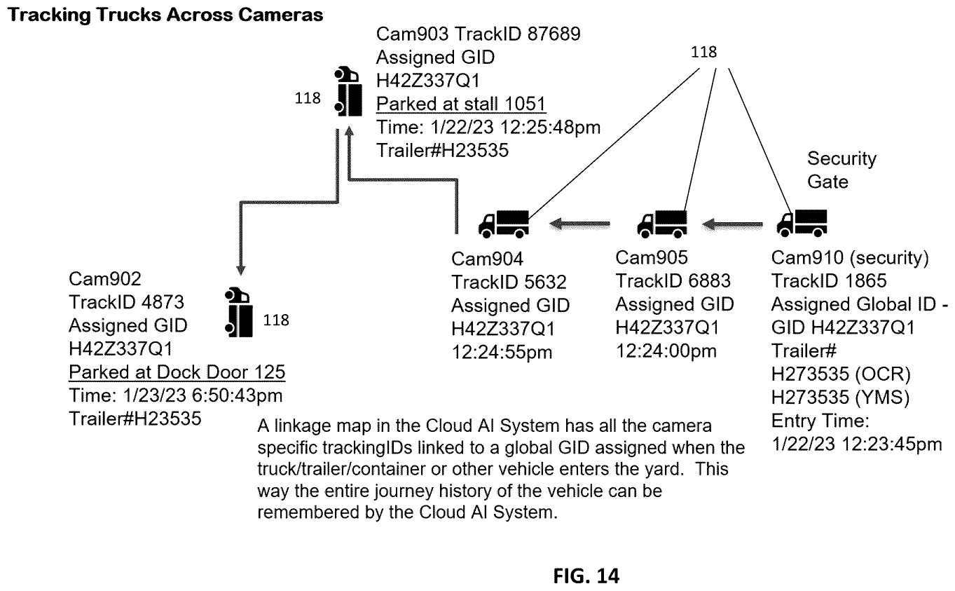

FIG. 14 shows a truck that enters the gate with a camera 200 specific tracking ID 1865. Its trailer details can be captured by the OCR system in the Cloud AI System. A unique Global ID (GID) can be created for the trailer—GID H42Z337Q1. It is assigned to the trailer details. The tractor-trailer moves through the camera 200 and utilizing the camera 200, the mapping neural network model can link this to the same GID as the truck that just went through the gate. Alternatively, it can use the Camera Linkage map to determine associated trailers from one camera to the next adjacent camera. In subsequent locations, the tractor-trailer can move across multiple cameras 200 and the GLOBAL ID H42Z337Q1 for that tractor-trailer can be linked to the camera specific tracking ID for that same vehicle. Date/Time data can be logged for each move of the tractor-trailer. Thus, the entire move history for the tractor-trailer can be created. This data can be shown in a web portal and can be compared to what the YMS 100′ believes happened in the trailer yard. Some tractor-trailers can be tracked but never park in parking stalls or dock doors. These are typically local delivery trucks to deliver supplies and packages to the facility but are not inventory for the DC supply chain operations. These trucks/trailers may never have been “checked-in” at the gate and its YMS system interface. These types of trucks/trailers can be tracked to visually log their movement and time in the trailer yard and at the distribution center to ensure that they do what they are supposed to do and are located where they should be. Alerts can be sent to distribution center personnel if conditions warrant. Other vehicles and humans can also be tracked as well for security and safety purposes and similar alerts are sent if conditions warrant.

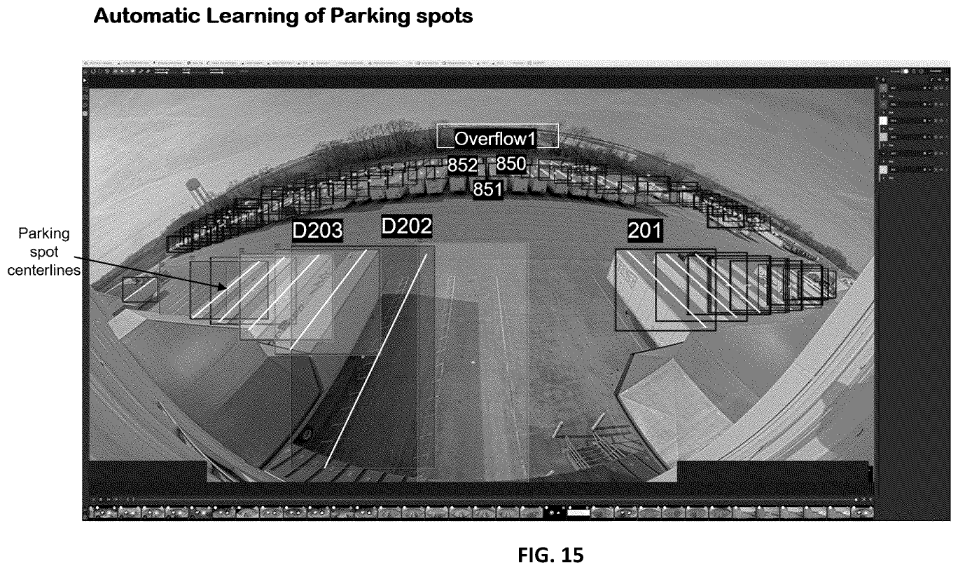

FIG. 15 shows a photo of how the individual parking stalls/positions can be automatically learned prior to deployment of the Yard Vision System, and then how human labeled names can be given to the parking positions and centerlines drawn of each parking position. After the yard learning period (approx. 1 week)—the trailer-top rectangles and trailer parking spot centerlines can be superimposed on the camera image for trucks that have been parked for a long period of time (e.g., 12 hours). A human annotator can then label each spot and parking spot centerline with a parking spot name that matches how the customers yard is laid out. General purpose regions can be labeled as Overflow1,Overflow2. . . . From this point forward all parking spots have a proper name and camera coordinate.

The process can be as follows: The JSON messages are sent from the Edge AI Camera Server to the Cloud AI System. This data contains all the parked and moving trucks for each frame of each camera 200. This data is collected in Cloud AI System for a period of time typically 1 week. Over this period nearly all parking positions may have been occupied by a trailer and its corresponding trailer top. Stationary parked trailers tops can be found by determining if the same tracking ID for that trailer top is in the same relative x,y camera position for that specific camera after several hours. As an example, while a trailer top may currently not be there, there may have been a stationary trailer in that position for a period of time during the last week of the learning period. This spot can be human labeled as D202 at calibration time. All trailer top rectangles that were stationary can be superimposed on an image for that camera 200. For any parking positions not found in the learning period a, trailer can be delivered to that position by trailer yard employees so the Cloud AI System can “learn” all parking spots. Alternatively, the learning period can be extended for another few days to collect the missing parking spots.

After all visible parking spots have at least one corresponding trailer top rectangle associated with it, then a human annotator can use a web tool to select the box with a mouse and enter a label that describes the parking position. The human annotator can also draw and label the centerline of the trailer and annotate it with the same parking position name as the rectangle that contains it. These names may match what is painted on the ground in front of each position to aid the drivers. Also, regions of the trailer yard can be defined by the human annotator as Overflow regions (e.g., Overflow 1, 2 . . . ) that can contain more than one parked trailer. These regions do not have a defined spot for each trailer but can support multiple trailers in these regions. This human annotation can be repeated for each camera and for the parking spots that each camera 200 oversees. Each camera 200 can be responsible for each dock door and parking stall out in the parking area. Web reporting can show specific trailers currently in each of these defined Overflow regions or parking spots.

It is understood that other automatic or manual learning of parking spots can be used. The automatic learning allows for an unattended approach to learn the yard and recommend probable parking spots and overflow positions. At any one time, all spaces are not full, and this automatic learning approach can allow an accumulation of data collected over the learning period to act as a parking spot recommender. One key advantage of this approach is that trailers are often slightly off-center positioned around the individual parking spot painted on the ground. There are long 53′ trailers and short 40′ containers that may occupy the parking space in the learning period. The union of all these trailer top regions can define the outer bounds of the parking ROI (region of interest) for that location with lines painted on the ground. The reason trailer tops may be preferred is that they are generally not occluded from a camera's 200 point of view. An Object Detection Yard model can be used to detect each trailer top even if most of the base trailer is occluded by another trailer between it and the camera 200. Once all parking spots are labeled, these labels and the coordinates for each rectangle can be stored in a database. They are called parking position ROI's (regions of interest). There may also be parking spot centerlines that denote the centerline top of where each trailer can park in its parking position. During live operations, these parking position ROI's can be compared to the trailer top centerpoints that are parked at the present time. Parking spot centerlines can be useful since long or short trailers/containers can park anywhere along the line and the system can still determine that the trailer is parked in that position number denoted by the centerline.

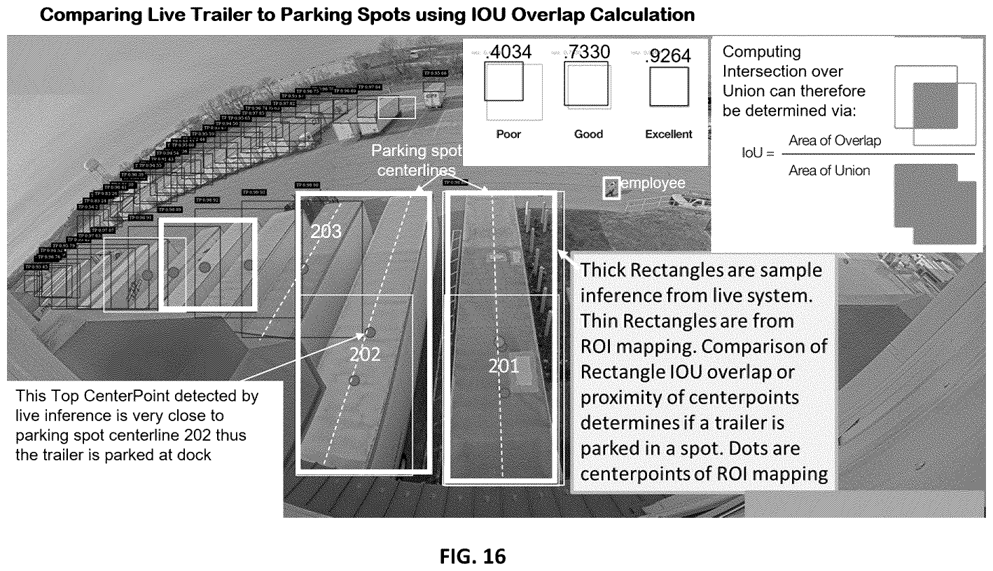

FIG. 16 shows how to determine if a trailer is parked in a specific parking spot. In the FIG., a live inference (object detection for a trailer top that is parked in that position) as denoted by a thick white rectangle. The thin rectangle(s) are the parking position ROI for that parking position as learned in the yard learning period. An Intersection over Union (IOU) calculation can be performed to compare the live inference rectangle to the Parking Position ROI's using the formula shown. IOU math is a proven technique used in machine vision applications to compare size and relative positioning of a reference rectangle and another rectangle. It gives a good correlation score that they overlap well. The IOU calculation can return a fraction, and if the number is low (e.g., 0.4034 then it has a Poor IOU). If the fraction is high (e.g., 0.9264 then it is an Excellent IOU). So, each trailer top detected in this frame can tested against the parking position ROI's for this camera. If the IOU score is high, then the parking position name can be determined. As can be seen in the image, the large white rectangle highly correlates to the parking position ROI for parking stall, as they are almost identical in size and position. These IOU calculations can be done every so often and don't need to be done each frame of the video for each camera 200.

In an alternate embodiment, the top centerpoint of the trailer that is detected by the live inference system can be compared to the parking spot centerlines using a perpendicular distance calculation (the normal). The centerpoint coordinates can be very close to the parking spot centerline that has been manually created by human annotators prior to going live. The parking spot can be determined by which centerline is closer to the top-center of the trailer that is parked. In FIG. 16 the trailer top center is very close to parking spot centerline thus the trailer is parked at dock 202. The centerline distance mapping approach works well for any size trailer that parks in line with the parking spot centerline. This parking spot determination logic can be used in addition to the IOU calculation above or in lieu of it.

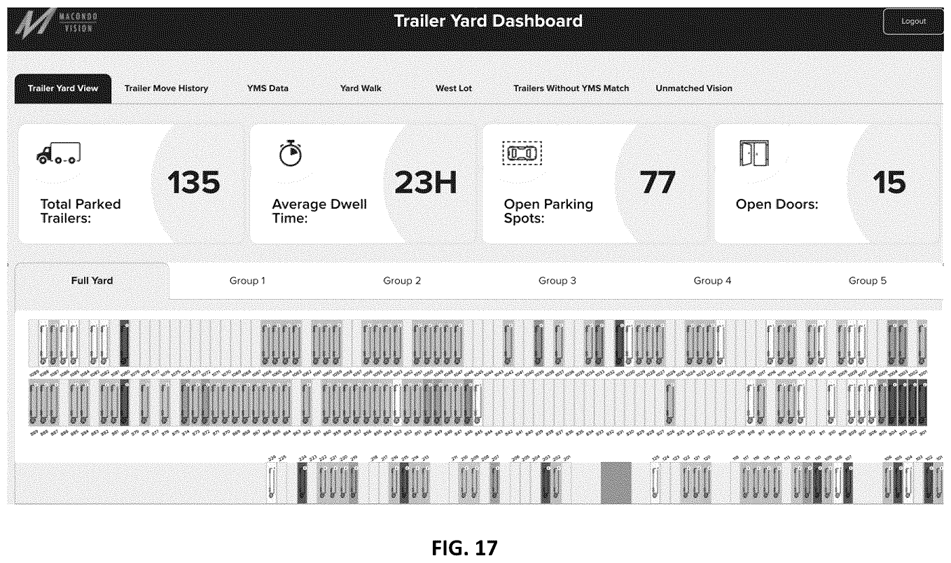

FIG. 17 shows a web-based dashboard with currently parked trailers in various parking spots based upon what the Cloud AI System determined. Each of the parking spots can be color coded based upon the time that the trailer has been present and other business rules. Recently parked trailers can be yellow, for example. Trailers that have been in their location for a very long period can be colored red, for example. Clear parking spots can indicate that there is no trailer in them. This information can be very important as monetary demurrage charges can occur if a 3^{rd} party trailer/container is kept in a yard past a determined amount of time. Demurrage reports can be shown to help prevent these charges. Trailers that have an error associated with them can be another color. For example, if the YMS 100′ data instructed this trailer to be parked elsewhere then a unique color can denote this to aid the operator of the web dashboard to remedy the problem. Each trailer ICON can have an associated information button associated with it. When this is clicked, details about the truck and its move history can be shown. Other key data shown to the operator can be the total parked trailers, the average dwell time of trailers, open parking spots available, open truck doors, etc. These give the trailer yard personnel and other management the ability to see what is going on with the trailer yard at the present time and plan accordingly. This can be a visualization of what is physically in the trailer yard right now. Other visualizations can be generated and shown, for example, so the staff can look back in time. Some trailer yards are very large, making it difficult to visualize on a single screen, so there can be Group buttons that allow the operator to view a select grouping of parking positions.

The web site can use secure login credentials and roles-based permissions to allow authorized users to view different sections of the web site. There can be tabs displayed across the top of the portal that allow the user to see all the trailer's move history, sorted by time, specific trailer ID, etc. Another tab can include YMS data that shows what was received by the YMS 100′. There can be a yard walk tab that allows a person walking/driving the trailer yard to manually update the web dashboard with the proper trailer numbers on an as needed case. There can be tabs associated with the various lots on the trailer yard premise to see what trailers are in those specific lots. There can be a tab called “Trailers Without YMS Match” showing trailers that are tracked by the Cloud AI System but that have no corresponding YMS 100′ entry. The Cloud AI System can attempt to match each trailer entry at the gate to each YMS 100′ entry done by the employee at the security gate. The matches are often done on a time matching basis and trailer number matching basis. If this matching cannot be found, then these trailers can be entered in the “Trailers without YMS match” tab. An employee can manually link them up or enter the correct trailer information into one or the other YMS 100′ or Cloud AI System 100. The web portal can allow the operator to search for any trailer ID or trailers that entered the yard at a certain time or moved around the yard at a certain time. This way when an employee needs to find a trailer it can be highlighted where it is currently parked as well as its entire move history. The trailer yard dashboard can have a configuration/layout tool to enable operators to “design the view” of their entire yard, including its parking spots, the positions of the buildings, the overflow areas, the entry gate and exit gates, entry areas from other yards, etc. This layout tool can allow the naming conventions used for that distribution center to be used in the dashboard at runtime. The Cloud AI system can present its data in the desired layout for the distribution center.

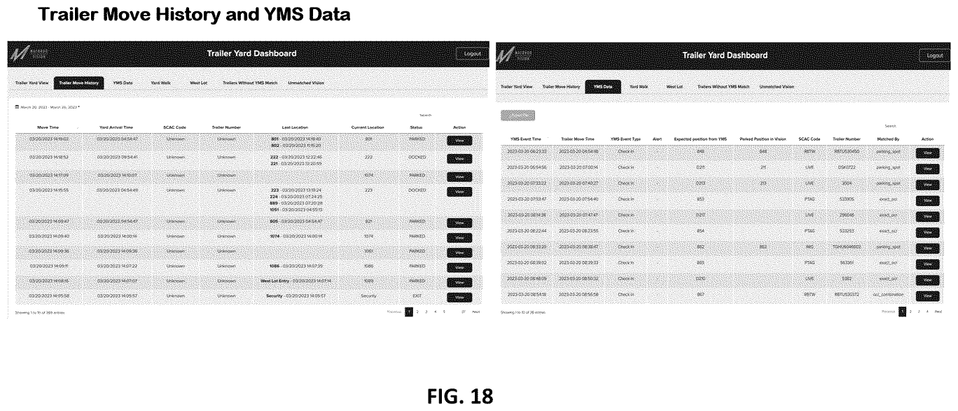

FIG. 18 shows web dashboards with trailer move history and the YMS data that has been received from the YMS 100′. The trailer move history can include move time, yard arrival time, SCAC code, trailer number, last locations that the trailer has been, the current location, the current status, etc. A view action button can allow the operator to drill down and see the detailed information about the entire journey of a specific trailer. A search feature can allow the operator to quickly search for various fields in the Cloud AI System database. YMS data fields can also be shown and may vary by customer. They may include YMS event time, trailer move time, YMS event type, alert status, expected parking position from YMS, parked position in Yard Vision System, SCAC code, trailer number, a matched by field that shows how the match was done to match the Yard Vision System read trailer number to the data sent in from the YMS 100′, etc. There can be situations in which no trailer number is seen by the camera 200 at the gate. This could be because the back door of the trailer is rolled up, the number is not readable for some reason like dirt, etc. In this situation, the matching can be based upon some other variable (e.g., if a trailer is seen entering the gate at the same time period or sequence as the YMS 100′ then they can be considered the same trailer). As another example, if the trailer moves across the yard and the vision system sees a trailer park in the same parking spot as a YMS 100′, then the match can be done by parking spot matching. The goal can be to allow both the YMS 100′ or the Cloud AI System 100 to be able to update each other or provide the information to allow a linkage of what the Cloud AI System X sees to what the YMS system 100 thinks happened in the yard. The synergy between the two systems can be uses to generate an optimized YMS system that accurately reflects the current state of the trailer yard and the history of trailer moves for the trailer yard.

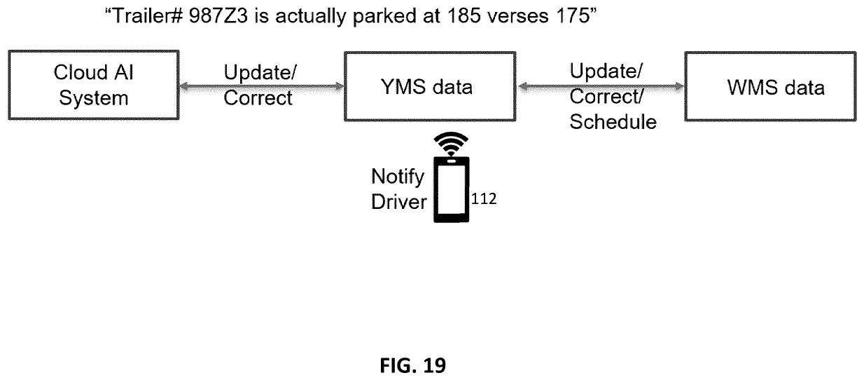

FIG. 19 shows the data linkage between the Cloud AI System, the YMS, and the WMS. All systems can integrate to each other through API gateways, message queues, or other data messaging systems. Each system can provide information to the other systems to aid in system functionality. Also, each system can provide update API calls to allow the remote system to update another system directly to build an automated system to increase transaction accuracy across the enterprise. This can allow for more efficient supply chain processes and lower the cost of operations. When errors or updates occur to any system, a notification to drivers, yard management, or warehouse management staff can occur using web portals or messaging. The Cloud AI System combined with an existing YMS 100′ can allow for rapid fixing of errors and notifications to appropriate personnel. The mobile messaging for example can message the driver that they just made a mistake and parked in the wrong parking spot. Thus, before they can disconnect the truck from the trailer/container they can pull out and remedy the problem. In nearly all transaction-based systems that require human intervention like handheld scans, typing entries in applications forms, picking up or dropping a load in a specific location, there is an opportunity for the action to be done wrong. For example, a guard at the gate can enter trailer data into the YMS 100′ wrong or out of order as they entered, the truck driver can park in the wrong location with the trailer for a myriad of reasons, etc. The Cloud AI System combined with the YMS 100′ can autocorrect many of these human errors and/or alert for these discrepancies.

In alternate embodiments, a truck driver can park the trailer in any available parking spot and the Cloud AI System or YMS 100′ can be automatically notified where the driver parks. This is an optimized system where the drivers can get into the trailer yard, drop off their trailer, and get out of the yard very fast. Drivers will tend to park in the easiest parking spot available and this Cloud AI System 100 can let other systems not limited to existing YMS 100′ know where all the trailers are. This can be referred to as a “Park where you want” feature of the Yard Vision System. Many distribution center facilities and trailer yards do not use a YMS 100′, and only the Yard Vision System is available. For unattended security gates this “Park where you want” is ideal method.

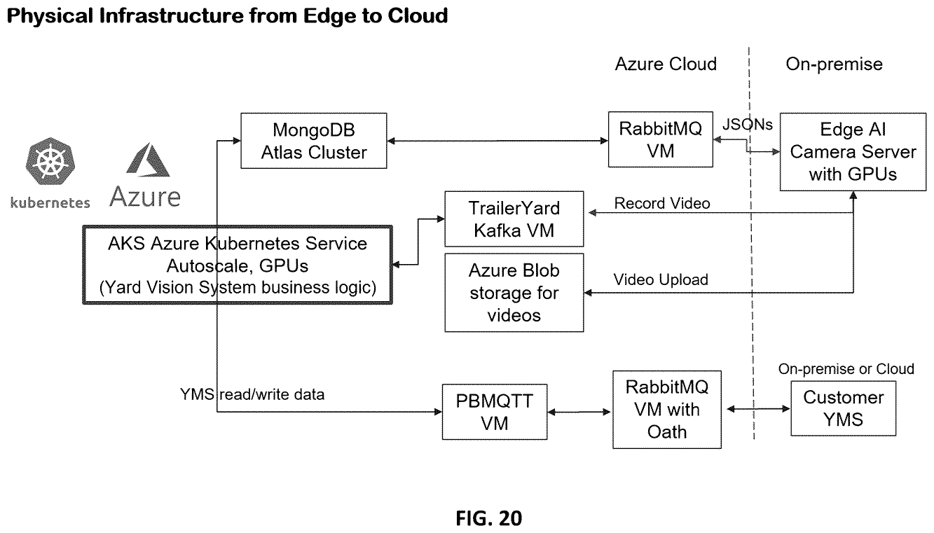

FIG. 20 shows a physical infrastructure for both on-premises and in the cloud. In the exemplary infrastructure, the on premises is the Edge AI Camera Server with GPUs running the edge based neural network models and the NVIDIA DeepStream™ software. The details of this Edge AI Camera Server and associated camera 200 infrastructure are discussed supra. This Edge AI Camera Server can connect to the Azure Cloud over a secure internet channel using https and VPN networks. The messaging can connect to a RabbitMQ Virtual Machine. RabbitMQ is an opensource message queue software. This virtual machine can be connected to a MongoDB Atlas cluster to store the inbound messages. Alternate message queue technology and database technology are contemplated by this embodiment. Azure Kubernetes service can provide physical and virtual servers to run the Cloud AI System. The Kubernetes service can provide standard cloud functionality like autoscale, GPUs to run high speed neural networks in the cloud, security, etc. It is contemplated that other Cloud technology platforms like Amazon AWS, Google Cloud, or others can be utilized. A Kafka Virtual Machine can allow business logic to message the Edge AI Camera Server or the RabbitMQ Virtual Machine can be alternatively used for this purpose. Typical messages sent over this Kafka VM can include a record video request to the Edge AI Camera Server. Azure Blob storage can be used to store the videos that are uploaded of gate transactions and yard alert transactions when errors occur, or security events occur. In the case where the distribution center utilizes a YMS 100′ an integration can occur using a RabbitMQ VM. This rabbit MQ can use OATH to securely connect to the Customers IT infrastructure. The messages can be secured over a VPN and use HTTPS. A PBMQTT Virtual Machine can reads the YMS data out of the Rabbit MQ VM and send the data to the Mongo DB Atlas Cluster. The Cloud AI System can use this data and provide updates and messages back to the YMS 100′. This YMS 100′ can exist on premises or in the cloud. In alternate embodiments all of this physical infrastructure can be hosted on site at the distribution center.

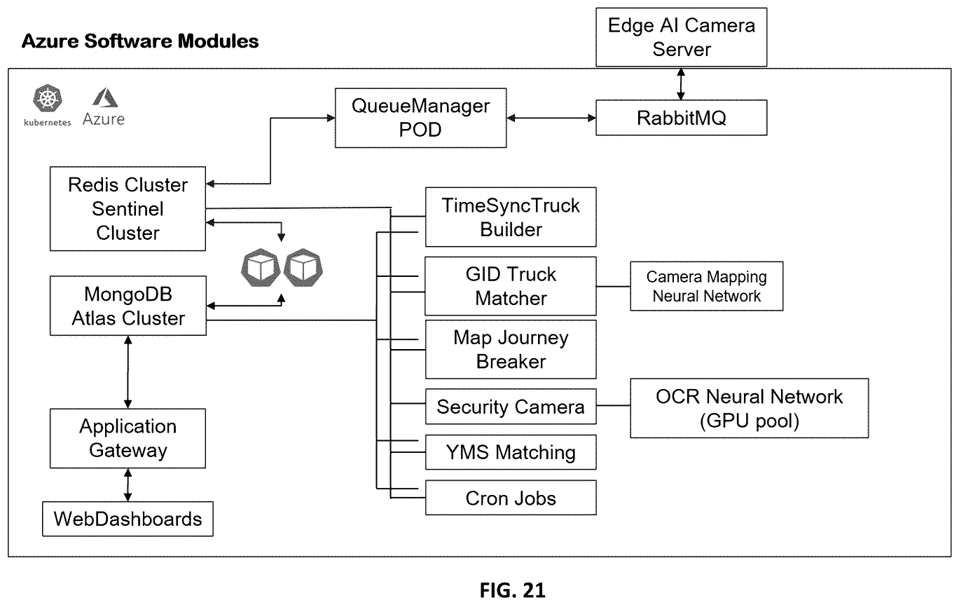

FIG. 21 shows Azure software modules that can run the Cloud AI System. JSON messages of object detections can be sent from the Edge AI Camera Server to the RabbitMQ service where they can be held until the QueueManager POD pulls them out and sorts them by camera 200. The data can be time bucketed for a few seconds by camera to keep the messages in sync for that camera 200. If a message comes in after the bucketing time, then it can be discarded. This data is then sent to a Redis Cluster Sentinel Cluster (an in memory high availability database) for very fast processing since there are so many inbound JSON messages for each camera.

Several software processes can use data stored in Redis to implement the Cloud AI System logic. For example, TimeSyncTruckBuilder can processes messages from Redis to create the global ID (GID) of a trailer, assign status and location to a trailer, keep all the old memory logs related to the past GIDs, etc. It can forward all trailers on the trailer yard roads to Redis for the GIDMatcher process. This module can make updates to the yard_location tables, trailer_event tables, etc. in the Redis database and the MongoDB. This TimeSyncTruckBuilder process POD can handle one camera 200 only. Thus, there can be one of these PODs running for each camera 200. The service can be written in the python language.

The next process is the GID Truck Matcher. This process can link one camera GID with another camera GID. It can leverage the camera mapping neural network. In alternate embodiments it uses the Coverage/Linkage Map. There can be a single POD running for all cameras 200, and the service can be in Python. This module can enter its data into the MongoDB Atlas cluster.

The next process is the Map Journey Breaker. This process can query the MongoDB on an interval and check for new broken journeys where a trailer has not been tracked properly. It can fix these broken journeys. This can be a single POD service, and can be written in python.

The next process is the Security Camera. This process can take gate camera messages from Redis and check for entry and exit of trailers. When a BACK of a trailer is detected by this process, it can be responsible for sending a message using Kafka or RabbitMQ to the Edge AI Camera Server to send a short video of the trailer as it enters the yard. This video can be uploaded to Azure storage blob and the security camera module can be notified by a JSON message the URL path to the video. Then, the Security Camera process can run the object detection gate model on the video to find the locations of all the numbers, logos, license plate, BACKs of the trailers, etc. These images can be sent to an OCR Neural Network GPU pool where OCR inferences can be done. High confidence alpha-numeric values returned from the OCR engine can be used for trailer information. In alternate embodiments, the video can be sent to 3rd party OCR services, cropped images and those services can implement the OCR, etc., which can then return values read.

The next process is the YMS Matching. The YMS data can be received every few minutes or real-time from the host YMS 100′. The business logic in this process can be responsible to match OCR engine generated trailer information to the YMS 100′ data received. Trailer number matching, time matching, sequence matching, parking position matching, and other matching can be completed in this module and updates can be made to a MondoDB Atlas cluster. When errors or discrepancies are found, the service can correct or recommend a correction to either the Cloud AI System or the YMS 100′.

The next process is Cron Jobs. There are many time-related activities that may have to be executed on the database. These cron jobs can run every 1 minute, and the service can be written in python.

The next process is the WebDashboard. This web-based dashboard can be used to show the data stored in the database to provide the desired functionality of the Cloud AI System. It can be serviced through an auto-scalable Application Gateway for authorized users. It can be written in Node JS and allow for multiple authenticated users to use the tool at the same time.

Interfaces to other systems are contemplated but not limited to: Drone and Robot services to monitor the yard, automated trailer systems, security systems, police systems, third party analytics companies, 3^{rd} party visualization firms that create “Digital Twin” of the operations of the facility, etc.

In alternate embodiments, the Cloud AI System can auto-learn everything that is happening in the yard by monitoring JSON data sent by the Edge AI Camera Server and data from existing YMS 100′. This data can be fed into a large language neural network model that is trained. All parking spots can be learned, all trailer moves across cameras can be learned, all trailer information can be associated with all trailer moves and parking, etc. A non-limiting example is a follows: the YMS 100′ says that a tractor-trailer ID #416A is entering the yard now and has been assigned to park in parking position 1089. The Cloud AI System can any track trailers moving around various cameras 200, and if a trailer parks in parking spot 1089, then the Cloud AI System 10 can “learn” that this physical spot is called 1089 and should have tracker-trailer ID416A associated with it. This “learning” can happen over multiple moves to this and other parking spots over a few weeks so that the “learning” model can earn all the names of all the parking spaces. Also, after this learning is complete, the Cloud AI System can detect errors when the driver parks in the wrong position. Notifications/updates can be made to other systems. Large Language models can be capable of digesting and training huge amounts of trailer JSON move data across multiple cameras, inject massive amounts of YMS data, make the inferences on which trailer info is associated with which moving and parked trailer on any camera, etc. The Large Language model can also learn motion flow paths across cameras 200 to automatically create a universal GID tracking ID for trailers seen on multiple cameras 200.

FIG. 20 shows an embodiment for the software architecture for the Cloud AI System. However alternate embodiments are contemplated including different cloud providers, programing languages, databases, virtualization processes, messaging protocols. Any or all these processes can be hosted in separate cloud services or on-premises infrastructure.

The Yard Vision System can provide these non-limiting use cases:
Contactless check-in-anywhere
   Camera verifies trailer/license plate against expected arrivals.
   Camera to verify driver's license against list.
   Sensor to open gate once verified check-in occurs.
   LCD Display at the Gate area to tell the driver where to park.
Passive tracking—of warehouse or factory yard locations for these objects:
   Of trailers
   Of containers
   Of trucks
   Of cars
   Humans
   With OCR done across any object that has readable numbers or other identification tags.
   To verify actual spots where trucks can park and then actually did park.
   To verify quality of parking by the driver (overlapping spots, hitting things, taking too long to park, etc.)
   To monitor safety events in the yard.
   To alert when done when threshold events occur.
   Special tracking options for hazmat material vehicles.
   Can direct vehicles to open locations in the yard and can be sent mobile message or audio alerts to driver that he made a mistake.
Passive tracking—of ports or rail yards for vehicles/containers/trains/trailers.
   Capture of container info
   Location of containers (in stacks)
   Count of movements of containers
   Other Yard Vision System features described for Yards at Distribution Centers
Visualizations
   Real time dashboard to show:
      Trailer info associated to parking spot/loading dock door.
      Duration on yard/in spot.
      Display of alerts that are issued and resolved.
      Trailers expected to have been brought to door/unloaded that have not been.
      Link to Purchase Order/Bill of Lading (via YMS/WMS) to show expected receipt date of goods to signal to users next best trailer to receive or which trailer has been closed to remove from shipping doors.
      Link (via WMS) to highlight where high priority or hazardous product is in the yard and how long it has been there
      Provide data visualization of areas of traffic to highlight where safety equipment can be added (when, where, and which trucks are speeding, where are turns dangerous, etc. . . . )
   Real time alerting mechanism for
      Aging trailers
      Safety incidents (collisions, near collisions, person walking in unauthorized zone, etc. . . .
Trailer/Container/Chassis quality check done via utilizing inspection cameras or data provided from a robot that moves around and under the trailer.
   Tire damage
   Structural damage
   Leakage
   The structure of the vehicle is scanned at entrance to the yard and at the exit from the yard. Neural networks determine if there is a change of state of the physical vehicle not limited to damage. Video logs are kept for these incidents as proof. Alerts are sent to Distribution Center 2 personal.
Data sales/connectivity
   Global positioning of trailers/containers across all customer properties.
   General trailer aging.
   General trailer counts
   Big data analytics to help customers see how they compare across each of their Yards and their competitors yards. This is to aid in human performance monitoring and efficiency evaluation.

It will be understood that modifications to the embodiments disclosed herein can be made to meet a particular set of design criteria. For instance, any of the components of the system or device can be any suitable number or type of each to meet a particular objective. Therefore, while certain exemplary embodiments of the system and methods of using the same disclosed herein have been discussed and illustrated, it is to be distinctly understood that the invention is not limited thereto but can be otherwise variously embodied and practiced within the scope of the following claims.

It will be appreciated that some components, features, and/or configurations can be described in connection with only one particular embodiment, but these same components, features, and/or configurations can be applied or used with many other embodiments and should be considered applicable to the other embodiments, unless stated otherwise or unless such a component, feature, and/or configuration is technically impossible to use with the other embodiments. Thus, the components, features, and/or configurations of the various embodiments can be combined in any manner and such combinations are expressly contemplated and disclosed by this statement.

It will be appreciated by those skilled in the art that the present invention can be embodied in other specific forms without departing from the spirit or essential characteristics thereof. The presently disclosed embodiments are therefore considered in all respects to be illustrative and not restrictive. The scope of the invention is indicated by the appended claims rather than the foregoing description and all changes that come within the meaning, range, and equivalence thereof are intended to be embraced therein. Additionally, the disclosure of a range of values is a disclosure of every numerical value within that range, including the end points.

What is claimed is:

1. A marshalling area monitoring system, comprising:
a camera module having one or more cameras configured to generate an output representative of a captured image and/or a video of a marshalling area including one or more objects entering, within, and/or leaving a marshalling area;
a state machine module configured to receive the output from the camera module, the state machine module including:
an inference engine configured to:
identify and track an object;
establish a state and/or a change in state of an object via machine vision inferencing; and
generate an output representative of an object identification, an object state, and/or a change in an object's state;
a mapping engine configured to:
process the camera module output to assign coordinates to an object contained in an image and/or a video based on a coordinate system of a computer vision map of a marshalling area;
apply a timestamp in connection with assigning coordinates to an object; and
generate a coordinate timeseries log for plural coordinate-timestamp pairs.

2. The marshalling area monitoring system of claim 1, wherein:
the inference engine is configured to identify and track an object based on one or more of a convolution neural network technique or a transformer technique.

3. The marshalling area monitoring system of claim 1, wherein:
an object includes one or more of a human, an animal, a vehicle, a tractor-trailer, a device, an item, or an article of clothing.

4. The marshalling area monitoring system of claim 1, wherein:
identifying an object includes one or more of:
identifying a type of an object as a human, an animal, a vehicle, a tractor-trailer, a device, an item, or an article of clothing; and
identifying a subtype of an object, including a class or category of a human, an animal, a vehicle, a device, an item, or an article of clothing.

5. The marshalling area monitoring system of claim 1, wherein identifying a state of an object includes one or more of:
determining or predicting whether an object is or will be authorized, unauthorized, admissible, not admissible, compliant, noncompliant, safe, or in danger;
determining or predicting whether an object is or will be in a proper location;
determining or predicting whether an object's behavior is or will be appropriate;
determining or predicting whether an object's movement, speed, or trajectory is or will be acceptable;
determining or predicting whether an occurrence is creating or will create a state or a change in state; or
determining or predicting whether a state of an object indicates it is likely to collide with another object.

6. The marshalling area monitoring system of claim 1, wherein:
a marshalling area includes one or more of a parking lot, an airport tarmac, a harbor, a marina, a shipping yard, a trucking yard, a railroad yard, a motorpool, a staging area, a distribution center, or warehouse.

7. The marshalling area monitoring system of claim 3, wherein:
a class of category of the human includes one or more of an employee, a contractor, an operator, a customer, a visitor, an authorized individual, or an unauthorized individual;
a class or category of the animal includes one or more of a dangerous animal or a non-dangerous animal;
a class or category of the vehicle includes one or more of a personal vehicle, a commercial vehicle, a delivery vehicle, a construction vehicle, a water vessel, an aircraft, a drone, an autonomous robot, bicycle, or a scooter;
a class or category of the device includes one or more of a computer, a camera, a surveillance apparatus, a tool, a piece of equipment, a weapon, or contraband;
a class of category of the item includes one or more of a light post, a barrier, a curb, a fence, a dock, a doorway, or an unidentified object; and
a class or category of the article of clothing includes work attire, non-work attire, safety attire, or personal protective equipment.

8. The marshalling area monitoring system of claim 1, wherein:
the inference engine is configured to identify and track an occurrence that will cause or is likely to cause a change in a state.

9. The marshalling area monitoring system of claim 1, wherein:
the inference engine is configured to determine a change in the state of an object based on plural states of an object and one or more tracked behavior, movement, and/or occurrence for each state of plural states.

10. The marshalling area monitoring system of claim 1, wherein:
the inference engine is configured to generate a trigger event signal based on a state of an object and/or a change in a state of an object.

11. The marshalling area monitoring system of claim 1, wherein:
the mapping engine is configured to assign coordinates to an object contained in an image and/or a video continuously, at predetermined times, when a change in movement or direction of an object is detected, and/or when an object is stationary for a predetermined time.

12. The marshalling area monitoring system of claim 1, wherein the state machine module is configured to:
identify an object by identifying one or more features that are unique to an object; and
associate one or more features that are unique to a marshalling area to a coordinate of the computer vision map.

13. The marshalling area monitoring system of claim 12, wherein:
identifying one or more unique features of an object includes identifying a text or number associated with an object via a text or number recognition technique.

14. The marshalling area monitoring system of claim 1, wherein:
the camera module output includes an image and/or a video at a point of ingress and/or at a point of egress of a marshalling area.

15. The marshalling area monitoring system of claim 1, wherein:
a camera of the camera module is configured to capture an image and/or a video of a marshalling area that at least partially overlaps in geometric space with an image and/or a video captured by another camera of the camera module.

16. The marshalling area monitoring system of claim 1, wherein:
the state machine module, using the coordinate timeseries log for the object, is configured to generate a time-in-marshalling area log for an object, the time-in-marshalling area log including one or more of:
time and location of entrance into a marshalling area;
time and location of object-in-stationary position;
time and location of object-in-motion; and
time and location of exit from a marshalling area.

17. The marshalling area monitoring system of claim 1, wherein:
the state machine module is configured to transmit the coordinate timeseries log to a data store;
the data store is part of the marshalling area monitoring system or part of a marshalling area management system that is separate from the marshalling area monitoring system; and/or
the marshalling area monitoring system is in communication with a marshalling area management system or is part of the marshalling area management system.

18. The marshalling area monitoring system of claim 1, wherein:
the state machine module is configured to receive sensor data from a sensor module and use a sensor fusion technique to augment or verify identification of an object, state of an object, change in state of an object, and/or assignment of coordinates to an object.

19. A yard management system, comprising:
marshalling area monitoring system of claim 1;
wherein the state machine module, using the coordinate timeseries log, is configured to generate a time-in-marshalling area log for an object, the time-in-marshalling area log including one or more of: time and location of entrance into a marshalling area; time and location of object-in-stationary position; time and location of object-in-motion; and time and location of exit from a marshalling area; and
a yard management system (YMS) module configured to transmit and/or receive data, via a bi-communication approach or protocol, to/from an asset management system (AMS).

20. The yard management system of claim 19, wherein:
an object includes at least a vehicle; and
an AMS is configured to, via a supply chain management technique, manage a vehicle and contents of a vehicle as assets.

21. The yard management system of claim 20, wherein:
the YMS module is configured to compare corresponding data from an AMS to verify accuracy of asset location.

22. The yard management system of claim 21, wherein:
the YMS module is configured to generate an output for updating the AMS or recommending an update to the AMS based on the comparison.

23. The yard management system of claim 19, wherein:
the YMS module is configured to transmit and/or receive data, via a bi-communication approach or protocol, to/from a security system.

24. The yard management system of claim 20, wherein:
an AMS is configured to control, coordinate, or track vehicle movement and placement within a marshalling area; and
a AMS has a predetermined staging or parking location for a vehicle, a vehicle stages or parks at a location that is at a discretion of a vehicle's operator, or a vehicle stages or parks at a location dictated by program logic or an artificial intelligence algorithm.

25. The yard management system of claim 20 in combination with an AMS, the yard management system comprising:
an application server in communication with the YMS module and configured to generate a user interface for display on a mobile electronic device of an operator of a vehicle;
wherein:
the AMS controls, coordinates, or tracks vehicle movement and placement within a marshalling area; and
the YMS module is configured to transmit a message via a user interface to a mobile electronic device based on data obtained via a bi-communication approach or protocol between the YMS module and the AMS.
